(19) United States
(12) Patent Application Publication
(10) Pub. No.: US 2003/0000840 A1
(43) Pub. Date: Jan. 2, 2003

(54) Electroplating apparatus and method

(76) Inventors: Norio Kimura, Fujisawa-shi (JP); Hiroaki Inoue, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/180,007

(22) Filed: Jun. 26, 2002

(30) Foreign Application Priority Data
Jun. 27, 2001 (JP) 2001-195430

(51) Int. Cl. C25B 9/00; C25B 9/04; C25B 15/00; C25C 3/16; C25C 3/20; C25D 17/00; C25D 5/00; C25D 21/12; C25F 7/00; B23H 3/02; B23H 7/04; B23H 7/14

(52) U.S. Cl. 205/81; 204/228.1; 204/229.8; 205/82; 205/83

(57) ABSTRACT

An electroplating apparatus and method that can detect the film thickness of a plated film, which is being deposited on the surface, to be plated, of a substrate, consecutively in real time, thereby enabling the detection of the end point of plating. The electroplating apparatus for plating a substrate by filling a plating solution between the substrate held by a substrate holding portion and an anode, and applying a voltage between the substrate and the anode, includes at least one of a voltage monitor for monitoring the voltage applied between the substrate and the anode, thereby detecting the end point of the electroplating, and a current monitor for monitoring an electric current that flows through a detection circuit, which is formed by connecting at least two cathode electrodes and to which a constant voltage is applied, thereby detecting the end point of the electroplating.

### BACKGROUND OF THE INVENTION

1. Field of the Invention

This invention relate to an electroplating apparatus and method, and more particularly to an electroplating apparatus and method that can detect the film thickness of a metal film, which is being deposited on the surface, to be plated, of a substrate such as a semiconductor wafer by electroplating, in real time, such a state that the substrate is held by a substrate holding portion, thereby enabling the detection of the end point of plating.

2. Description of the Related Art

In recent years, instead of using aluminum or aluminum alloys as a material for forming interconnection circuits on a substrate such as a semiconductor wafer, there is an eminent movement towards using copper (Cu) which has a low electric resistance and high electromigration resistance. Copper interconnects are generally formed by filling fine recesses formed in the surface of a substrate with copper. There are known various techniques for forming such copper interconnects, including CVD, sputtering, and plating. According to any such technique, a copper film is formed in the substantially entire surface of a substrate, followed by removal of unnecessary copper by chemical mechanical polishing (CMP).

FIGS. 10A through 10C illustrate, in sequence of process steps, an example of forming such a substrate W having copper interconnects. As shown in FIG. 10A, an insulating film 2, such as an oxide film of Sio₂ or a film of low-k material, is deposited on a conductive layer 1a in which electronic devices are formed, which is formed on a semiconductor base 1. A contact hole 3 and a trench 4 for interconnects are formed in the insulating film 2 by the lithography/etching technique. Thereafter, a barrier layer 5 of TaN or the like is formed on the entire surface, and a seed layer 7 as an electric supply layer for electroplating is formed on the barrier layer 5.

Then, as shown in FIG. 10B, copper plating is performed onto the surface of the substrate W to fill the contact hole 3 and the trench 4 with copper and, at the same time, deposit a copper film 6 on the insulating film 2. Thereafter, the copper film 6 and the barrier layer 5 on the insulating film 2 are removed by chemical mechanical polishing (CMP) so as to make the surface of the copper film 6 filled in the contact hole 3 and the trench 4 for interconnects and the surface of the insulating film 2 lie substantially on the same plane. An interconnection composed of the copper film 6 as shown in FIG. 10C is thus formed.

With respect to electroplating, the film thickness of a plated film can be controlled by controlling the total supply of electricity at a predetermined level. Accordingly, it has been generally practiced to control the film thickness of a plated film at a desired level by controlling the plating current at a predetermined value and, in addition, by controlling the plating time.

However, in forming interconnects e.g. in a semiconductor device, particularly in forming copper interconnects by electroplating, the initial current value can change according to the initial state of a seed layer. When copper plating is carried out under control of the plating time but under such a changeable electric current, there may undesirably be a case where the plated film becomes too thick, leading to a prolonged polishing time in the next CMP step, or a case where the plated film becomes too thin, resulting in insufficient embedding of copper.

### SUMMARY OF THE INVENTION

The present invention has been made in view the above situation in the related art. It is therefore an object of the present invention to provide an electroplating apparatus and method that can detect the film thickness of a plated film, which is being deposited on the surface, to be plated, of a substrate, consecutively in real time, thereby enabling the detection of the end point of plating.

In order to achieve the above object, the present invention provides an electroplating apparatus for plating a substrate for plating a substrate by filling a plating solution between the substrate and an anode, and by applying a voltage between the substrate and the anode, comprising: a voltage monitor for monitoring the voltage applied between the substrate and the anode, and detecting the end point of the electroplating.

With this arrangement, a film thickness of a metal film, which is being deposited on the surface, to be plated, of a substrate, can be measured consecutively in real time so as to detect the end point of plating.

The monitoring of the voltage applied between the substrate and the anode may be carried out while the plating is in progress.

The present invention also provides an electroplating apparatus for plating a substrate for plating a substrate by filling a plating solution between the substrate and an anode, and by applying a voltage between the substrate and the anode, comprising: a detection circuit which is formed by connecting at least two cathode electrodes that are for use in the plating; a detection power source for applying a constant voltage to the detection circuit; and a current monitor for monitoring an electric current that flows through the detection circuit and detecting the end point of the electroplating.

The monitoring of the electric current that flows through the detection circuit may be carried out while the plating is interrupted.

The present invention further provides an electroplating apparatus for plating a substrate for plating a substrate by filling a plating solution between the substrate and an anode, and by applying a voltage between the substrate and the anode, comprising: a voltage monitor for monitoring the voltage applied between the substrate and the anode, and detecting the end point of the electroplating; a detection circuit which is formed by connecting at least two cathode electrodes that are for use in the plating; a detection power source for applying a constant voltage to the detection circuit; and a current monitor for monitoring an electric current that flows through the detection circuit and detecting the end point of the electroplating.

According to this apparatus, the monitoring of the voltage applied between the substrate and the anode may be carried out while the plating is in progress, whereas the monitoring of the electric current that flows through the detection circuit may be carried out while the plating is interrupted.

The present invention also provides an electroplating method, comprising: plating a substrate by filling a plating solution between the substrate held by a substrate holding portion and an anode, and by applying a voltage between the substrate and the anode; and monitoring the voltage applied between the substrate and the anode so as to detect the end point of the electroplating.

The present invention further provides an electroplating method, comprising: plating a substrate by filling a plating solution between the substrate held by a substrate holding portion and an anode, and by applying a voltage between the substrate and the anode; forming a detection circuit by connecting at least two cathode electrodes that are for use in the plating; and applying a constant voltage to the detection circuit and monitoring an electric current that flows through the detection circuit so as to detect the end point of the electroplating.

The above and other objects, features, and advantages of the present invention will be apparent from the following description when taken in conjunction with the accompanying drawings which illustrates preferred embodiments of the present invention by way of example.

### BRIEF DESCRIPTION OF THE DRAWINGS

FIG. 1 is a plan view of an electroplating apparatus according to an embodiment of the present invention;

FIG. 2 is a sectional view taken along the line A-A of FIG. 1;

FIG. 3 is a cross-sectional view of a substrate holding portion and a cathode portion;

FIG. 4 is a cross-sectional view of an electrode arm portion;

FIG. 5 is a plan view showing the electrode arm portion from which a housing is removed;

FIG. 6 is a schematic view of an anode and a plating solution impregnable material;

FIG. 7 is an equivalent circuit diagram of the electroplating apparatus of FIG. 1;

FIG. 8 is a graph showing the relationship between the voltage and the plating time in an electroplating carried out under a constant electric current;

FIG. 9 is a circuit diagram showing a detection circuit in accordance with the present invention;

FIGS. 10A through 10C are diagrams illustrating, in sequence of process steps, an example of the formation of copper interconnects by copper plating;

FIG. 11 is a plan view of an example of a substrate plating apparatus;

FIG. 12 is a schematic view showing airflow in the substrate plating apparatus shown in FIG. 11;

FIG. 13 is a cross-sectional view showing airflows among areas in the substrate plating apparatus shown in FIG. 11;

FIG. 14 is a perspective view of the substrate plating apparatus shown in FIG. 11, which is placed in a clean room;

FIG. 15 is a plan view of another example of a substrate plating apparatus;

FIG. 16 is a plan view of still another example of a substrate plating apparatus;

FIG. 17 is a plan view of still another example of a substrate plating apparatus;

FIG. 18 is a view showing a plan constitution example of the semiconductor substrate processing apparatus;

FIG. 19 is a view showing another plan constitution example of the semiconductor substrate processing apparatus;

FIG. 20 is a view showing still another plan constitution example of the semiconductor substrate processing apparatus;

FIG. 21 is a view showing still another plan constitution example of the semiconductor substrate processing apparatus;

FIG. 22 is a view showing still another plan constitution example of the semiconductor substrate processing apparatus;

FIG. 23 is a view showing still another plan constitution example of the semiconductor substrate processing apparatus;

FIG. 24 is a view showing a flow of the respective steps in the semiconductor substrate processing apparatus illustrated in FIG. 23;

FIG. 25 is a view showing a schematic constitution example of a bevel and backside cleaning unit;

FIG. 26 is a view showing a schematic constitution of an example of an electroless plating apparatus;

FIG. 27 is a view showing a schematic constitution of another example of an electroless plating apparatus;

FIG. 28 is a vertical sectional view of an example of an annealing unit;

FIG. 29 is a transverse sectional view of the annealing unit; and

FIG. 30 is a schematic sectional view of an electroplating apparatus according to another embodiment of the present invention.

### DETAILED DESCRIPTION OF THE PREFERRED EMBODIMENTS

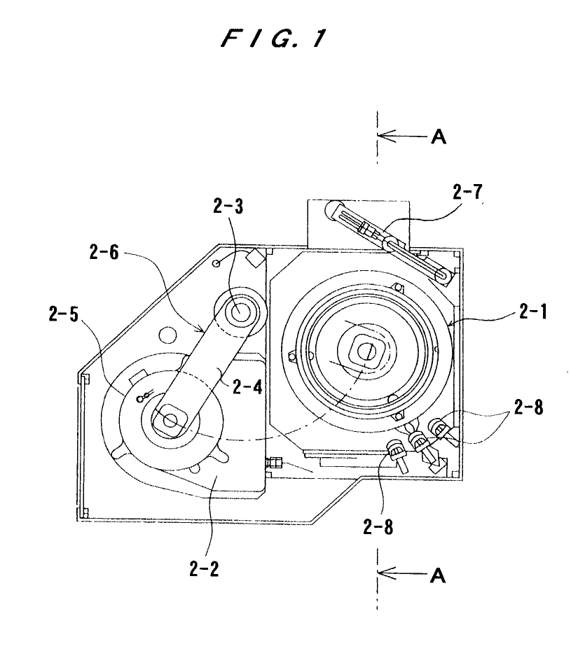

Preferred embodiments of the present invention will now be described with reference to the FIGS. 1 through 6.

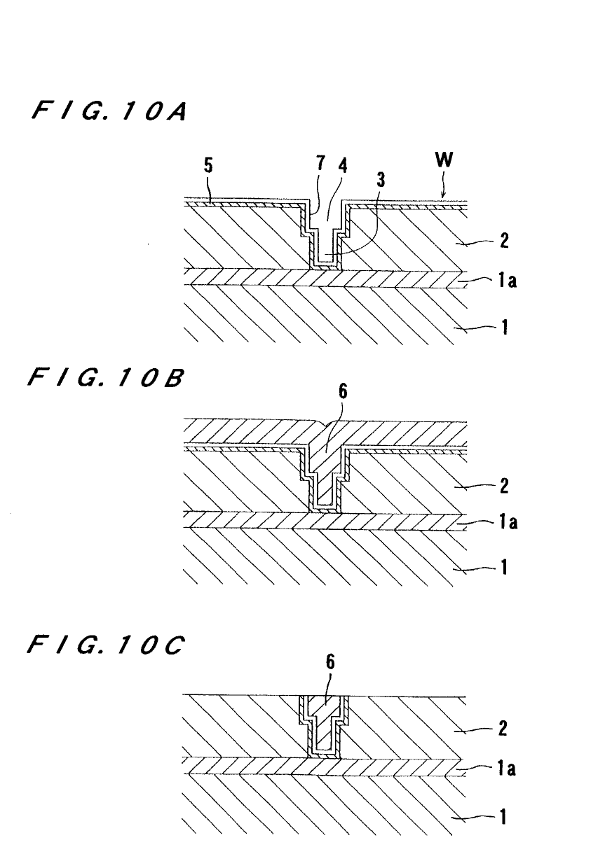

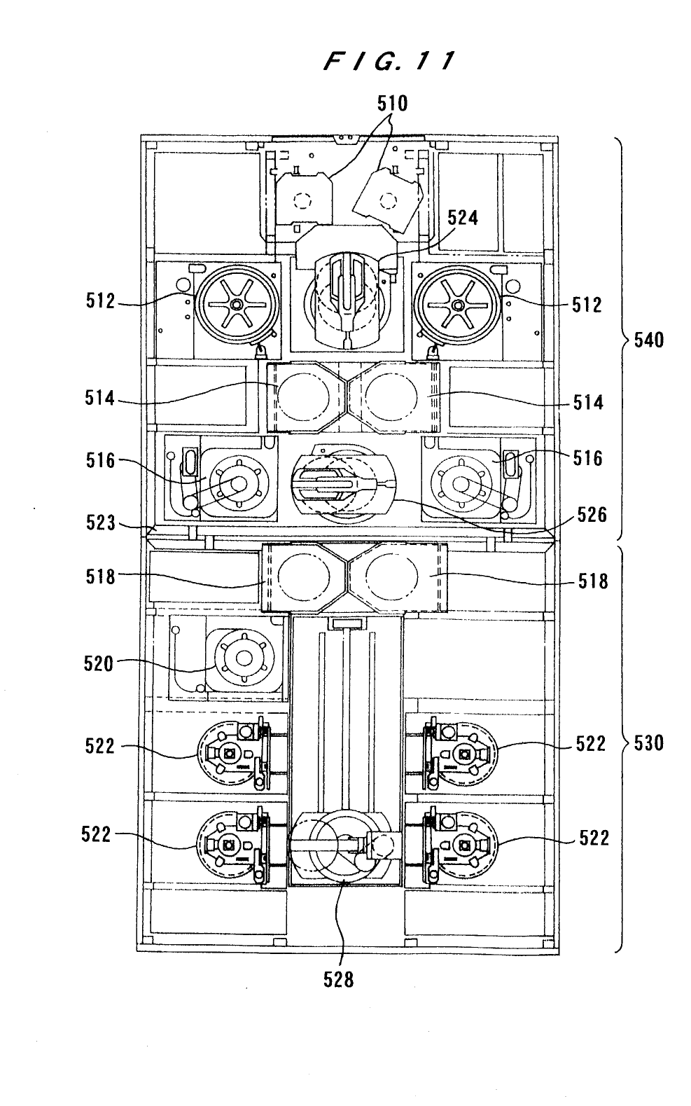

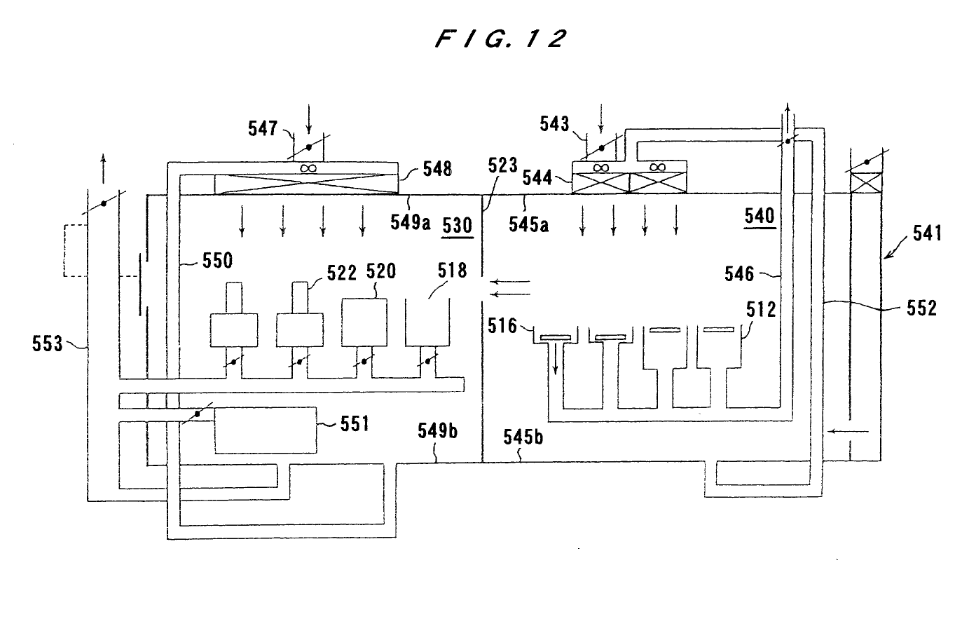

FIGS. 1 through 6 show an electroplating apparatus for forming copper interconnects, shown in FIG. 10, by electroplating onto a surface, to be plated, of a substrate, such as a semiconductor wafer. The electroplating apparatus, as shown in FIG. 1, is provided with a substrate treatment section 2-1 for performing plating treatment and its attendant treatment, and a plating solution tray 2-2 for storing a plating solution is disposed adjacent to the substrate treatment section 2-1. There is also provided an electrode arm portion 2-6 having an electrode portion 2-5 which is held at the front end of an arm 2-4 swingable about a rotating shaft 2-3 and which is swung between the substrate treatment section 2-1 and the plating solution tray 2-2.

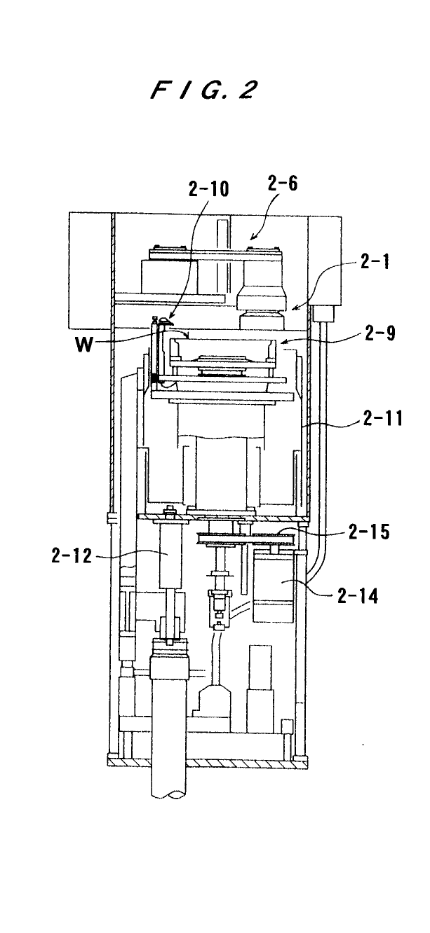

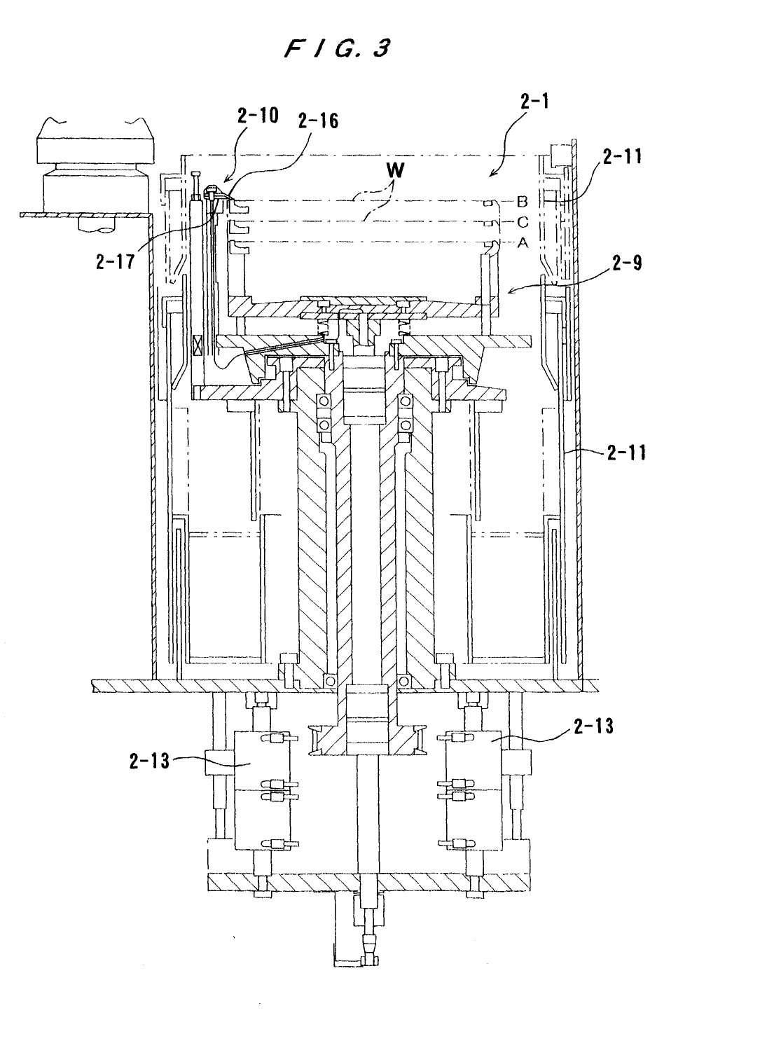

Furthermore, a precoating and recovery arm 2-7, and fixed nozzles 2-8 for ejecting pure water or a chemical liquid such as ion water, and further a gas or the like toward a semiconductor substrate are disposed laterally of the substrate treatment section 2-1. In this case, three of the fixed nozzles 2-8 are disposed, and one of them is used for supplying pure water. The substrate treatment section 2-1, as shown in FIGS. 2 and 3, has a substrate holding portion 2-9 for holding a semiconductor substrate W with its surface to be plated facing upward, and a cathode portion 2-10 located above the substrate holding portion 2-9 so as to surround a peripheral portion of the substrate holding portion 2-9. Further, a substantially cylindrical bottomed cup 2-11 surrounding the periphery of the substrate holding portion 2-9 for preventing scatter of various chemical liquids used during treatment is provided so as to be vertically movable by an air cylinder 2-12.

The substrate holding portion 2-9 is adapted to be raised and lowered by the air cylinder 2-12 between a lower substrate transfer position A, an upper plating position B, and a pretreatment and cleaning position C intermediate between these positions. The substrate holding portion 2-9 is also adapted to rotate at an arbitrary acceleration and an arbitrary velocity integrally with the cathode portion 2-10 by a rotating motor 2-14 and a belt 2-15. A substrate carry-in and carry-out opening (not shown) is provided in confrontation with the substrate transfer position A in a frame side surface of the electroplating apparatus facing the transferring robot (not shown). When the substrate holding portion 2-9 is raised to the plating position B, a seal member 2-16 and a cathode electrode 2-17 of the cathode portion 2-10 are brought into contact with the peripheral edge portion of the semiconductor substrate W held by the substrate holding portion 2-9. On the other hand, the cup 2-11 has an upper end located below the substrate carry-in and carry-out opening, and when the cup 2-11 ascends, the upper end of the cup 2-11 reaches a position above the cathode portion 2-10, as shown by imaginary lines in FIG. 3.

When the substrate holding portion 2-9 has ascended to the plating position B, the cathode electrode 2-17 is pressed against the peripheral edge portion of the semiconductor substrate W held by the substrate holding portion 2-9 for thereby allowing electric current to pass through the semiconductor substrate W. At the same time, an inner peripheral end portion of the seal member 2-16 is brought into contact with an upper surface of the peripheral edge of the semiconductor substrate W under pressure to seal its contact portion in a watertight manner. As a result, the plating solution supplied onto the upper surface of the semiconductor substrate W is prevented from seeping from the end portion of the semiconductor substrate W, and the plating solution is prevented from contaminating the cathode electrode 2-17.

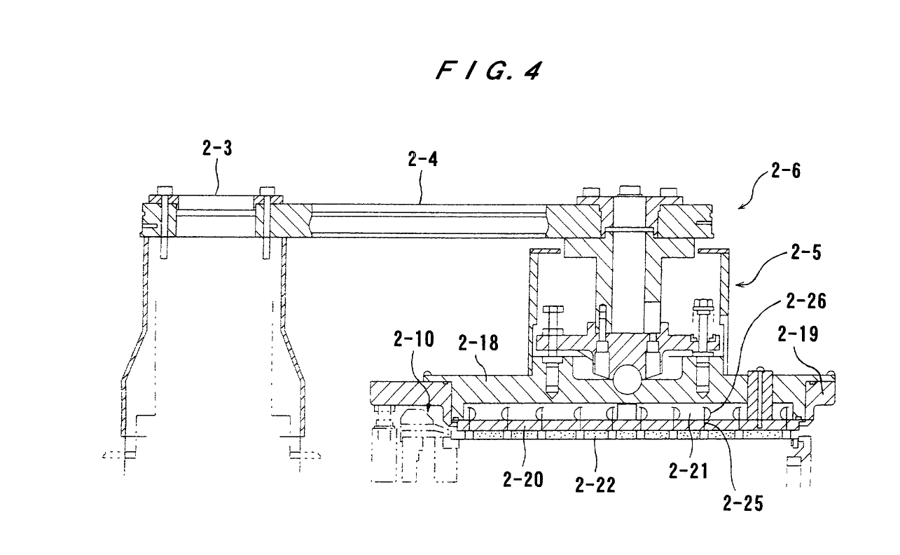

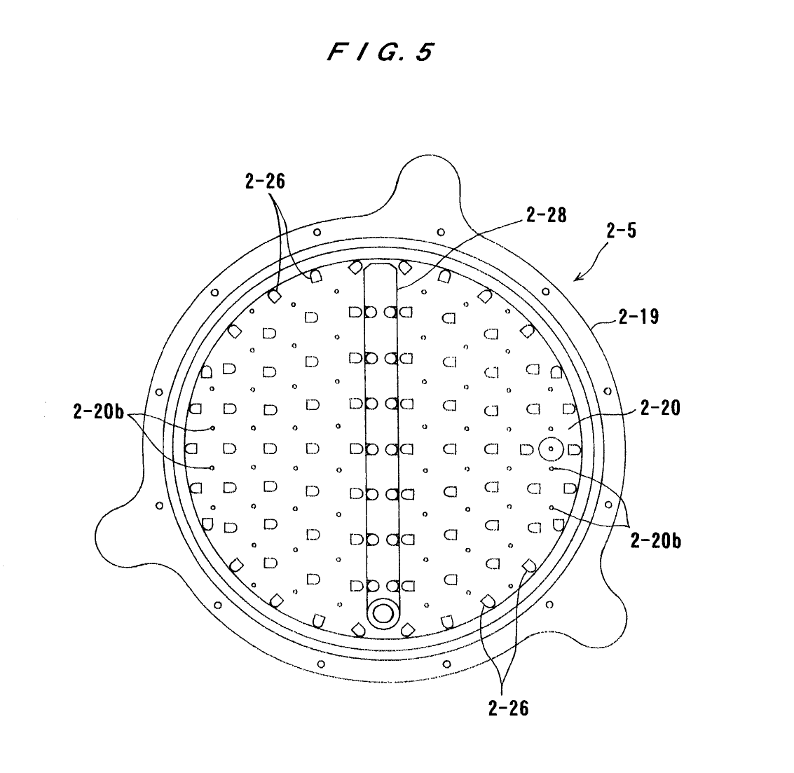

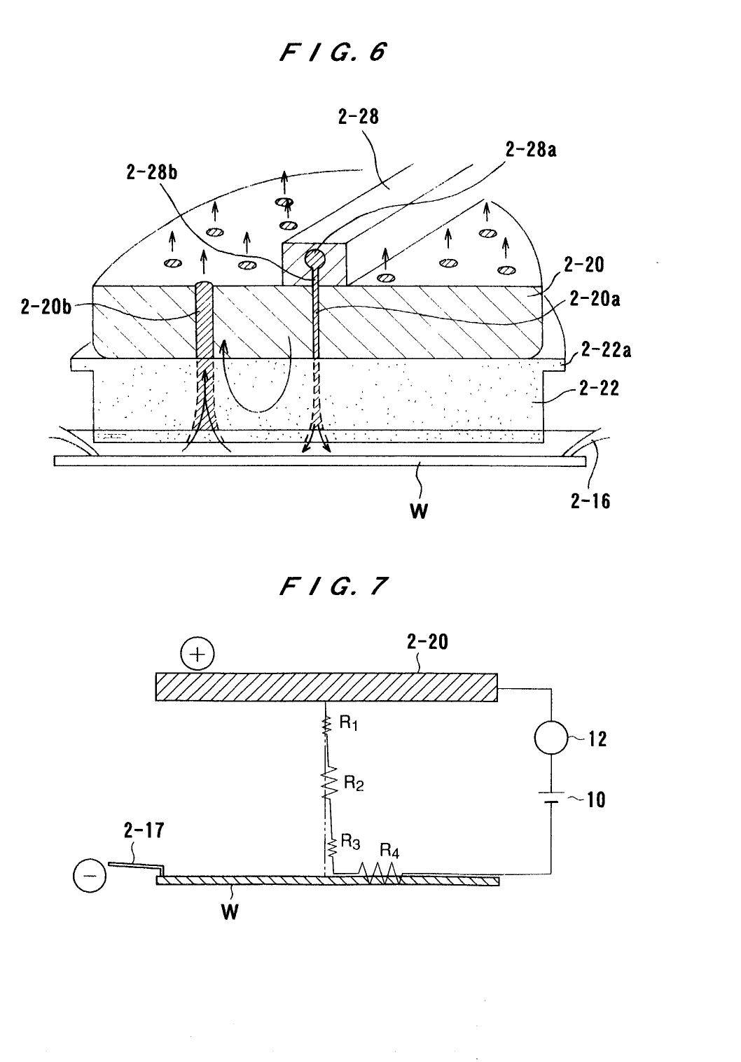

As shown in FIG. 4, an electrode portion 2-5 of the electrode arm portion 2-6 has a housing 2-18 at a free end of a swing arm 2-4, a hollow support frame 2-19 surrounding the housing 2-18, and an anode 2-20 fixed by holding the peripheral edge portion of the anode 2-20 between the housing 2-18 and the support frame 2-19. The anode 2-20 covers an opening portion of the housing 2-18, and a suction chamber 2-21 is formed inside the housing 2-18. Further, as shown in FIGS. 5 and 6, a plating solution introduction pipe 2-28 and a plating solution discharge pipe (not shown) for introducing and discharging the plating solution are connected to the suction chamber 2-21. Further, many passage holes 2-20b communicating with regions above and below the anode 2-20 are provided over the entire surface of the anode 2-20.

In this embodiment, a plating solution impregnated material 2-22 comprising a water retaining material and covering the entire surface of the anode 2-20 is attached to the lower surface of the anode 2-20. The plating solution impregnated material 2-22 is impregnated with the plating solution to wet the surface of the anode 2-20, thereby preventing a black film from falling onto the plated surface of the substrate, and simultaneously facilitating escape of air to the outside when the plating solution is poured between the surface, to be plated, of the substrate and the anode 2-20. The plating solution impregnated material 2-22 comprises, for example, a woven fabric, nonwoven fabric, or sponge-like structure comprising at least one material of polyethylene, polypropylene, polyester, polyvinyl chloride, Teflon, polyvinyl alcohol, polyurethane, and derivatives of these materials, or comprises a porous ceramics.

Attachment of the plating solution impregnated material 2-22 to the anode 2-20 is performed in the following manner: That is, many fixing pins 2-25 each having a head portion at the lower end are arranged such that the head portion is provided in the plating solution impregnated material 2-22 so as not to be releasable upward and a shaft portion of the fixing pin pierces the interior of the anode 2-20, and the fixing pins 2-25 are urged upward by U-shaped leaf springs 2-26, whereby the plating solution impregnated material 2-22 is brought in close contact with the lower surface of the anode 2-20 by the resilient force of the leaf springs 2-26 and is attached to the anode 2-20. With this arrangement, even when the thickness of the anode 2-20 gradually decreases with the progress of plating, the plating solution impregnated material 2-22 can be reliably brought in close contact with the lower surface of the anode 2-20. Thus, it can be prevented that air enters between the lower surface of the anode 2-20 and the plating solution impregnated material 2-22 to cause poor plating.

Incidentally, columnar pins made of PVC (polyvinyl chloride) or PET (polyethylene terephthalate) and having a diameter of, for example, about 2 mm may be arranged from the upper surface side of the anode so as to pierce the anode, and an adhesive may be applied to the front end surface of each of the pins projecting from the lower surface of the anode to fix the anode to the plating solution impregnated material. The anode and the plating solution impregnated material may be used in contact with each other, but it is also possible to provide a gap between the anode and the plating solution impregnated material, and perform plating treatment while holding the plating solution in the gap. This gap is selected from a range of 20 mm or less, but is preferably selected from a range of 0.1 to 10 mm, and more preferably 1 to 7 mm. Particularly, when a soluble anode is used, the anode is dissolved from its lower portion. Thus, as time passes, the gap between the anode and the plating solution impregnated material enlarges and forms a gap in the range of 0 to about 20 mm.

The electrode portion 2-5 descends to such a degree that when the substrate holding portion 2-9 is located at the plating position B (see FIG. 3), the gap between the substrate W held by the substrate holding portion 2-9 and the plating solution impregnated material 2-22 reaches about 0.1 to 10 mm, preferably 0.3 to 3 mm, and more preferably about 0.5 to 1 mm. In this state, the plating solution is supplied from a plating solution supply pipe to be filled between the upper surface (surface to be plated) of the substrate W and the anode 2-20 while the plating solution impregnated material 2-22 is impregnated with the plating solution. The surface, to be plated, of the substrate W is plated by applying a voltage from a power source 10 to between the upper surface (surface to be plated) of the substrate W and the anode 2-20.

FIG. 7 shows an equivalent electrical circuit of the copper electroplating apparatus.

When a voltage is applied from the power source 10 to between the anode 2-20 (anodic electrode) and the seed layer 7 (cathodic electrode, see FIG. 10) formed in the substrate W, the both electrodes being immersed in the plating solution, the electrical circuit formed has the following resistance components:

R1: anodic polarization resistance

R2: plating solution resistance

R3: cathodic polarization resistance

R4: sheet resistance

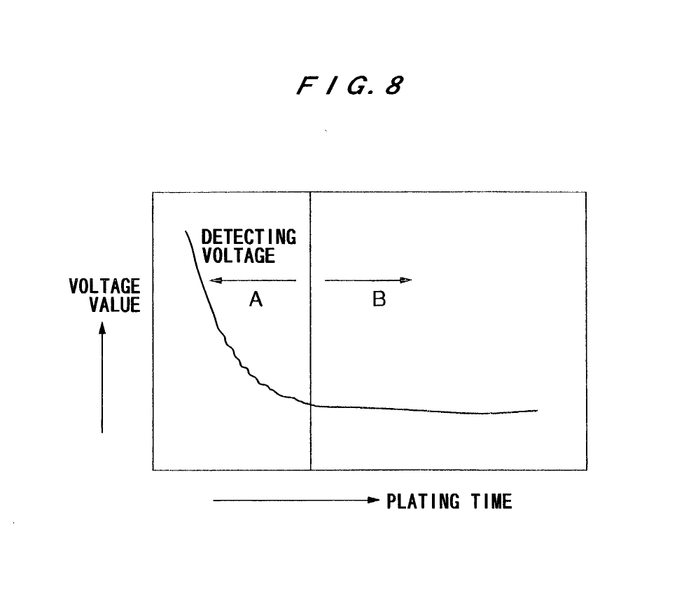

Assuming that the film thickness of the seed layer 7 is 25 nm, for example, the anodic polarization resistance R1 will be 7 mΩ, the plating solution resistance R2 will be 32 mΩ,the cathodic polarization resistance R3 will be 66 mΩ, and the sheet resistance R4 will be 585 mΩ, the percentage of the sheet resistance R4 thus reaching 82% of the total resistance. The sheet resistance R4 decreases as the plated film being deposited on the seed layer 7, i.e. the copper film 6 (see FIG. 10), becomes thicker. When the sheet resistance R4 decreases with an increase in the film thickness of the plated film, in a case where the electric current flowing through the circuit is controlled at a constant value, the voltage gradually decreases, as shown in FIG. 8, and becomes nearly constant when the film thickness of the plated film reaches a certain level.

In view of this, according to this embodiment, a voltage monitor 12 is provided within the circuit to monitor, in real time, the voltage applied between the anode 2-20 (anodic electrode) and the seed layer 7 (cathodic electrode) when the electric current is controlled at a constant value, and detect the voltage consecutively so as to measure the film thickness of the plated film. The end point of electroplating can be detected by detecting the decrease of the voltage to a predetermined value.

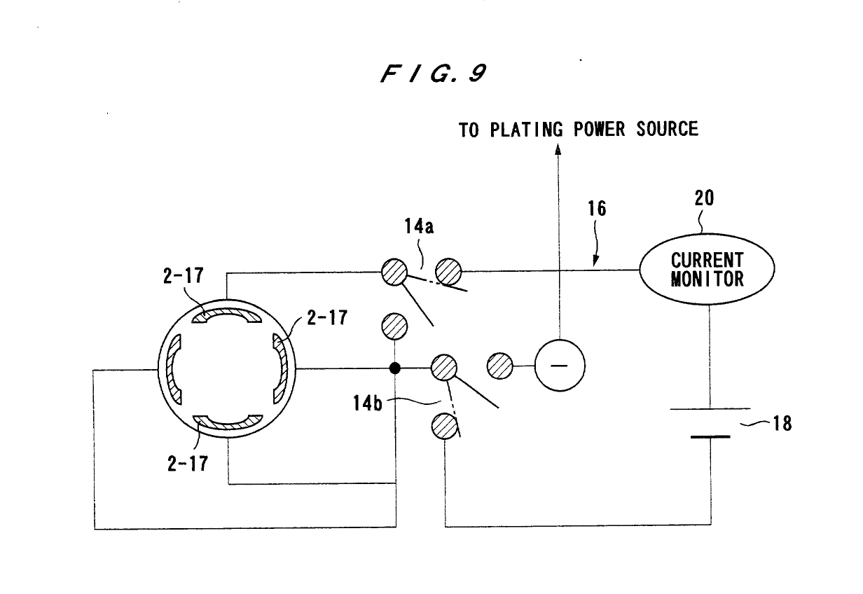

Further according to this embodiment, as shown in FIG. 9, a detection circuit 16, which connected at lease two cathode electrodes 2-17 with the copper film 6 (see FIG. 10), can be formed by providing switches 14a and 14b in the wiring to the cathode electrodes 2-17 and switching them. A detection power source 18 and a current monitor 20 are provided in the detection circuit 16. While the plating is interrupted and the switches 14a and 14b are switched, a constant voltage is applied from the detection power source 18 to the detection circuit 16, and the electric current that flows through the detection circuit 16 is monitored and detected by the current monitor 20 so as to measure the film thickness of the plated film. The end point of electroplating can be detected by detecting the increase of the electric current to a predetermined value. In this regard, the electric current, which flows through the detection circuit 16, changes with the change in the sheet resistance R4. The change of electric current with the change of resistance can be made large by applying a high voltage to the circuit 16. By plotting the current values detected, the film thickness of the copper film 6 can be inferred and the end point of the electroplating can be detected.

Depending upon the plating conditions, there are a case where the end point of electroplating is detected in the region A, shown in FIG. 8, in which the voltage applied between the anode 2-20 (anodic electrode) and the seed layer 7 (cathodic electrode) from the power source 10 gradually decreases, and a case where the end point of electroplating is detected in the region B, shown in FIG. B, in which the voltage keeps nearly constant. According to this embodiment, the end point of electroplating in the voltage-decreasing region A is detected by the voltage monitor 12, and the end point of electroplating in the region B is detected by the current monitor 20.

The monitoring of voltage or electric current may also be practiced by calculating differential values thereof. After detecting that the voltage or electric current has reached a predetermined value, it is possible to carry out an additional plating for a predetermined time. Further, it is possible to use the monitored signals as a trigger for changing the plating conditions.

The plating treatment carried out in the electroplating apparatus of this embodiment will now be described.

First, a semiconductor substrate W before the plating treatment is transferred by the transferring robot to the substrate holding portion 2-9 in the substrate transfer position A and placed on the substrate holding portion 2-9. The cup 2-11 is then raised and, at the same time, the substrate holding portion 2-9 is raised to the pretreatment and cleaning position C. The precoating and recovery arm 2-7 in the retreat position is moved to a position where the precoating and recovery arm 2-7 faces the semiconductor substrate W, and a precoating solution, comprising e.g. a surfactant, is intermittently ejected from a precoating nozzle provided at the end of the precoating and recovery arm 2-7 onto the surface, to be plated, of the semiconductor substrate W. The precoating is carried out while rotating the substrate holding portion 2-9, so that the precoating solution can spread over the entire surface of the semiconductor substrate W. After completion of the precoating, the precoating and recovery arm 2-7 is returned to the retreat position, and the rotating speed of the substrate holding portion 2-9 is increased to scatter by centrifugal force the precoating solution on the surface, to be plated, of the semiconductor substrate W to thereby dry the substrate. Then, substrate holding portion 2-9 is raised to the plating position B.

Subsequently, the electrode arm portion 2-6 is swung horizontally so that the electrode portion 2-5 moves from above the plating solution tray 2-2 to above a position for plating, and then the electrode portion 2-5 is lowered toward the cathode portion 2-10. After the electrode portion 2-5 has reached the plating position, a plating voltage is applied between the anode 2-20 and the cathode portions 2-10, while a plating solution is fed inside the electrode portion 2-5 and supplied to the plating solution impregnable material 2-22 through plating solution supply holes penetrating the anode 2-20. At this time, the plating solution impregnable material 2-22 is not in contact with but close to the surface, to be plated, of the semiconductor substrate W generally at a distance of about 0.1 to 10 mm, preferably about 0.3 to 3 mm, more preferably about 0.5 to 1 mm.

When the supply of the plating solution is continued, the plating solution containing copper ions, oozing out of the plating solution impregnable material 2-22, comes to fill the interstice between the plating solution impregnable material 2-22 and the surface, to be plated, of the semiconductor substrate W, whereupon Cu plating of the surface, to be plated, of the semiconductor substrate W starts. At this time, the substrate holding portion 2-9 may be rotated at a low speed.

When the end point of the electroplating is to be detected in the region A, shown in FIG. 8, in which the voltage applied from the power source 10 to between the anode 2-20 (anodic electrode) and the seed layer 7 (cathodic electrode) gradually decreases, the voltage is monitored by the voltage monitor 12 and the end point of the electroplating is detected by detecting the decrease of the voltage to a predetermined value. On the other hand, when the end point of the electroplating is to be detected in the region B, shown in FIG. 8, in which the voltage keeps nearly constant, the plating is interrupted and the switches 14a and 14b are switched to form the detection unit 16. A constant voltage is applied from the detection power source 18 to the detection circuit 16, and the electric current that flows through the detection circuit 16 is monitored by the current monitor 20. The end point of the electroplating is detected by detecting the increase of the electric current to a predetermined value.

After completion of the plating treatment, the electrode arm portion 2-6 is raised and then swung so that the electrode portion 2-5 is returned to above the plating solution tray 2-2, and the electrode portion 2-5 is then lowered to the normal position. Next, the precoating and recovery arm 2-7 is moved from the retreat position to the position where the precoating and recovery arm 2-7 faces the semiconductor substrate W. The precoating and recovery arm 2-7 is then lowered, and the plating solution remaining on the semiconductor substrate W is recovered through a plating solution-recovering nozzle (not shown). After completion of the recovery of the remaining plating solution, the precoating and recovery arm 2-7 is returned to the retreat position. Thereafter, pure water is ejected toward the center of the semiconductor substrate W and, at the same time, the substrate holding portion 2-9 is rotated at a high speed, thereby replacing the plating solution on the surface of the semiconductor substrate W with pure water.

After the above rinsing treatment, the substrate holding portion 2-9 is lowered from the plating position B to the pretreatment and cleaning position C, where water washing of the substrate is carried out by supplying pure water from the fixed nozzle 2-8 for pure water supply while rotating the substrate holding portion 2-9 and the cathode portion 2-10. In this treatment, the sealing member 2-16 and the cathode electrodes 2-17 can also the cleaned, simultaneously with the semiconductor substrate W, by the pure water supplied directly to the cathode portion 2-10 or by the pure water scattered from the surface of the semiconductor substrate W.

After completion of the water washing, the supply of pure water from the fixed nozzle 2-8 is stopped, and the rotating speed of the substrate holding portion 2-9 and the cathode portion 2-10 is increased to scatter by centrifugal force the pure water on the surface of the semiconductor substrate W to thereby dry the substrate. Simultaneously therewith, the sealing member 2-16 and the cathode electrodes 2-17 can also be dried. After the drying, the rotation of the substrate holding portion 2-9 and the cathode portion 2-10 is stopped, and the substrate holding portion 2-9 is lowered to the substrate transfer position A.

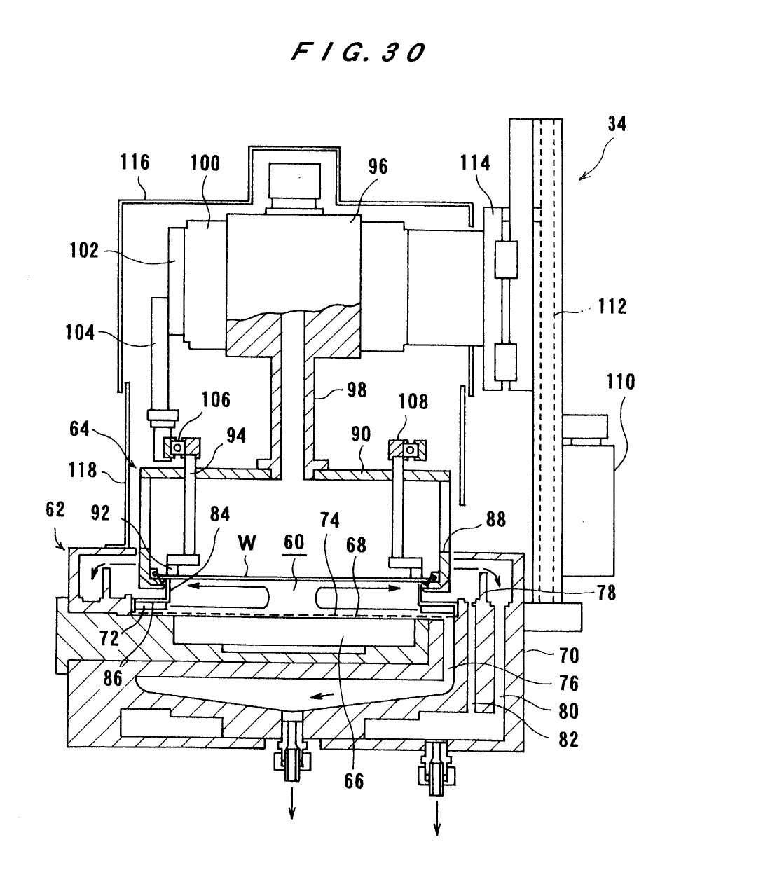

FIG. 30 shows an electroplating apparatus 34, which mainly comprises a substantially cylindrical plating tank 62 for holding a plating solution 60, and a plating head 64 disposed above the plating tank 62 and adapted to hold the substrate W. FIG. 30 shows a state of the electroplating apparatus 34 being at a plating position at which the substrate W is held by the plating head 64 and the liquid level of the plating solution 60 is raised.

The plating tank 62 has a plating chamber 68 open upward and having an anode 66 disposed at the bottom, and a plating vessel 70 containing the plating solution 60 in the plating chamber 68. On the inner circumferential wall of the plating vessel 70, plating solution ejection nozzles 72 horizontally protruding toward the center of the plating chamber 68 are arranged at equal intervals along the circumferential direction. These plating solution ejection nozzles 72 communicate with a plating solution supply passage extending vertically within the plating vessel 70.

A punch plate 74 provided with many holes, for example, of about 3 mm is disposed at a position above the anode 66 in the plating chamber 68 so as to thereby prevent a black film, which is formed on the surface of the anode 66, from being brought up by the plating solution 60 and flowed out.

The plating vessel 70 is also provided with a first plating solution discharge port 76 for pulling out the plating solution 60 in the plating chamber 68 from the peripheral edge of the bottom of the plating chamber 68, a second plating solution discharge port 80 for discharging the plating solution 60 which has overflowed a dam member 78 provided in an upper end portion of the plating vessel 70, and a third plating solution discharge port 82 for discharging the plating solution before overflowing the dam member 78. The plating solutions flowing through the second plating solution discharge port 80 and the third plating solution discharge port 82 are mixed at a lower end portion of the plating vessel 70 and discharged.

Because of this structure, when the amount of a plating solution 60 supplied is large during plating, the plating solution 60 is discharged to the outside through the third plating solution discharge port 82, and simultaneously caused to overflow the dam member 78 and discharged to the outside through the second plating solution discharge port 80. When the amount of a plating solution 60 supplied is small during plating, the plating solution 60 is discharged to the outside through the third plating solution discharge port 82, and simultaneously caused to pass through an opening (not shown) provided in the dam member 78, and discharged to the outside through the second plating solution discharge port 80. These contrivances permit easy adaptation to the magnitude of the amount of the plating solution.

Near the periphery of the interior of the plating chamber 68, a vertical stream regulating ring 84 and a horizontal stream regulating ring 86 are disposed by having the outer peripheral end of the horizontal stream regulating ring 86 secured to the plating vessel 70. These stream regulating rings 84 and 86 serve to push up the center of the plating solution surface by an upper flow of the plating solution 60 divided into upper and lower flows in the plating chamber 68, to smooth the lower flow, and make the distribution of an electric current density more uniform.

The plating head 64 has a rotatable, bottomed, cylindrical housing 90 open downward and having an opening 88 in a circumferential wall thereof, and vertically movable press rods 94 having a press ring 92 attached to the lower ends thereof.

The housing 90 is connected to an output shaft 98 of a motor 96, and is adapted to rotate by driving of the motor 96. The press rods 94 are suspended at predetermined positions along the circumferential direction of a ring-shaped support frame 108 rotatably supported via a bearing 106 at the lower end of a slider 104 movable upward and downward by the actuation of a guide-equipped cylinder 102 secured to a support 100 surrounding the motor 96. Thus, the press rods 94 move up and down according to the actuation of the cylinder 102, and when the substrate W is held, are adapted to rotate integrally with the housing 90.

The support 100 is mounted on a slide base 114 screwed to, and moving upward and downward integrally with, a ball screw 112 rotating in accordance with the driving of a motor 110. Further, the support 100 is surrounded with an upper housing 116, and moved up and down together with the upper housing 116 in accordance with the driving of the motor 110. A lower housing 118 surrounding the periphery of the housing 90 during plating is attached to the upper surface of the plating vessel 70.

The plating treatment carried out in the electroplating apparatus 34 to the surface of the substrate in such a state that the substrate is held by the plating head 64 with its surface, to be plated, facing downward.

The electroplating apparatus 34 is also provided with a voltage monitor within a circuit to monitor a voltage applied between the anode 66 and the seed layer 7 of the substrate W, and/or a detection circuit provided with switches, a detective power source and a current monitor so as to detect the end point of electroplating.

According to the present invention, as described hereinabove, the film thickness of a metal film deposited on the surface, to be plated, of a substrate can be detected in real time, whereby the end point of electroplating can be detected. This can prevent, e.g. in the formation of copper interconnects by copper plating, the polishing time in CMP from being prolonged and the embedding of copper from becoming insufficient.

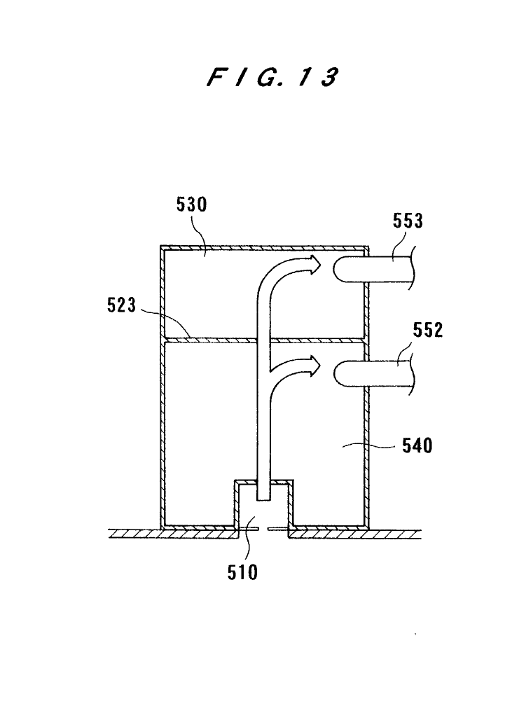

FIG. 11 is a plan view of an example of a substrate plating apparatus. The substrate plating apparatus comprises loading/unloading sections 510, each pair of cleaning/drying sections 512, first substrate stages 514, bevel-etching/chemical cleaning sections 516 and second substrate stages 518, a washing section 520 provided with a mechanism for reversing the substrate through 180°, and four plating apparatuses 522. The plating substrate apparatus is also provided with a first transferring device 524 for transferring a substrate between the loading/unloading sections 510, the cleaning/drying sections 512 and the first substrate stages 514, a second transferring device 526 for transferring a substrate between the first substrate stages 514, the bevel-etching/chemical cleaning sections 516 and the second substrate stages 518, and a third transferring device 528 for transferring the substrate between the second substrate stages 518, the washing section 520 and the plating apparatuses 522.

The substrate plating apparatus has a partition wall 523 for dividing the plating apparatus into a plating space 530 and a clean space 540. Air can individually be supplied into and exhausted from each of the plating space 530 and the clean space 540. The partition wall 523 has a shutter (not shown) capable of opening and closing. The pressure of the clean space 540 is lower than the atmospheric pressure and higher than the pressure of the plating space 530. This can prevent the air in the clean space 540 from flowing out of the plating apparatus and can prevent the air in the plating space 530 from flowing into the clean space 540.

FIG. 12 is a schematic view showing an air current in the plating substrate apparatus. In the clean space 540, a fresh external air is introduced through a pipe 543 and pushed into the clean space 540 through a high-performance filter 544 by a fan. Hence, a down-flow clean air is supplied from a ceiling 545a to positions around the cleaning/drying sections 512 and the bevel-etching/chemical cleaning sections 516. A large part of the supplied clean air is returned from a floor 545b through a circulation pipe 552 to the ceiling 545a, and pushed again into the clean space 540 through the high-performance filter 544 by the fan, to thus circulate in the clean space 540. A part of the air is discharged from the cleaning/drying sections 512 and the bevel-etching/chemical cleaning sections 516 through a pipe 546 to the exterior, so that the pressure of the clean space 540 is set to be lower than the atmospheric pressure.

The plating space 530 having the washing sections 520 and the plating apparatuses 522 therein is not a clean space (but a contamination zone). However, it is not acceptable to attach particles to the surface of the substrate. Therefore, in the plating space 530, a fresh external air is introduced through a pipe 547, and a down-flow clean air is pushed into the plating space 530 through a high-performance filter 548 by a fan, for thereby preventing particles from being attached to the surface of the substrate. However, if the whole flow rate of the down-flow clean air is supplied by only an external air supply and exhaust, then enormous air supply and exhaust are required. Therefore, the air is discharged through a pipe 553 to the exterior, and a large part of the down-flow is supplied by a circulating air through a circulation pipe 550 extended from a floor 549b, in such a state that the pressure of the plating space 530 is maintained to be lower than the pressure of the clean space 540.

Thus, the air returned to a ceiling 549a through the circulation pipe 550 is pushed again into the plating space 530 through the high-performance filter 548 by the fan. Hence, a clean air is supplied into the plating space 530 to thus circulate in the plating space 530. In this case, air containing chemical mist or gas emitted from the washing sections 520, the plating sections 522, the third transferring device 528, and a plating solution regulating bath 551 is discharged through the pipe 553 to the exterior. Thus, the pressure of the plating space 530 is controlled so as to be lower than the pressure of the clean space 540.

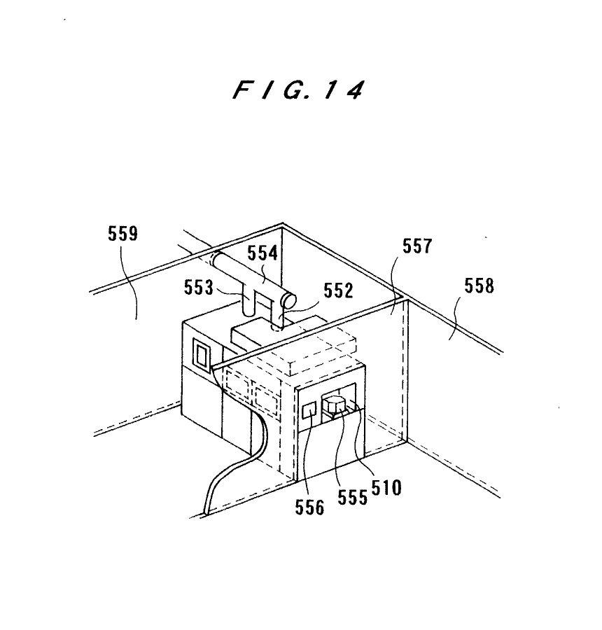

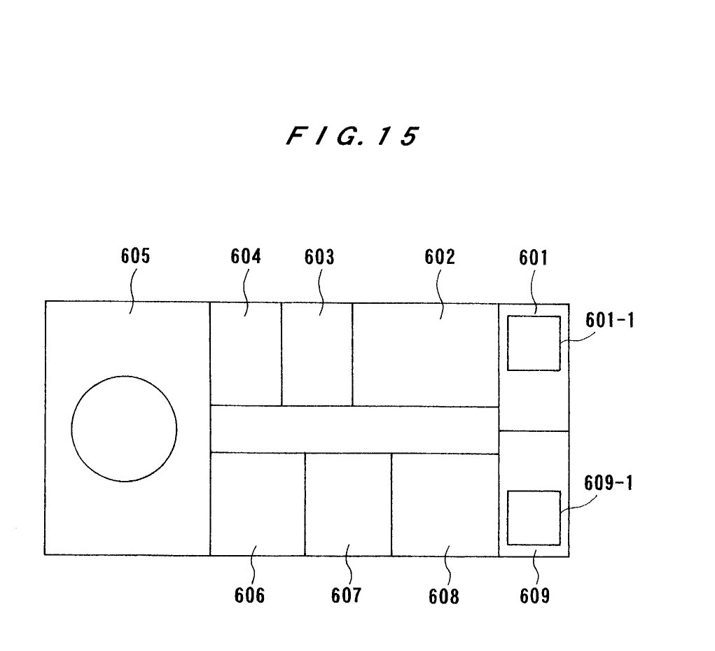

The pressure in the loading/unloading sections 510 is higher than the pressure in the clean space 540 which is higher than the pressure in the plating space 530. When the shutters (not shown) are opened, therefore, air flows successively through the loading/unloading sections 510, the clean space 540, and the plating space 530, as shown in FIG. 13. Air discharged from the clean space 540 and the plating space 530 flows through the ducts 552, 553 into a common duct 554 (see FIG. 14) which extends out of the clean room.

FIG. 14 shows in perspective the substrate plating apparatus shown in FIG. 11, which is placed in the clean room. The loading/unloading sections 510 includes a side wall which has a cassette transfer port 555 defined therein and a control panel 556, and which is exposed to a working zone 558 that is compartmented in the clean room by a partition wall 557. The partition wall 557 also compartments a utility zone 559 in the clean room in which the substrate plating apparatus is installed. Other sidewalls of the substrate plating apparatus are exposed to the utility zone 559 whose air cleanness is lower than the air cleanness in the working zone 558.

FIG. 15 is a plan view of another example of a substrate plating apparatus. The substrate plating apparatus shown in FIG. 15 comprises a loading unit 601 for loading a semiconductor substrate, a copper plating chamber 602 for plating a semiconductor substrate with copper, a pair of water cleaning chambers 603, 604 for cleaning a semiconductor substrate with water, a chemical mechanical polishing unit 605 for chemically and mechanically polishing a semiconductor substrate, a pair of water cleaning chambers 606, 607 for cleaning a semiconductor substrate with water, a drying chamber 608 for drying a semiconductor substrate, and an unloading unit 609 for unloading a semiconductor substrate with an interconnection film thereon. The substrate plating apparatus also has a substrate transfer mechanism (not shown) for transferring semiconductor substrates to the chambers 602, 603, 604, the chemical mechanical polishing unit 605, the chambers 606, 607, 608, and the unloading unit 609. The loading unit 601, the chambers 602, 603, 604, the chemical mechanical polishing unit 605, the chambers 606, 607, 608, and the unloading unit 609 are combined into a single unitary arrangement as an apparatus.

The substrate plating apparatus operates as follows: The substrate transfer mechanism transfers a semiconductor substrate W on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to one of the water cleaning chambers 603, 604 by the substrate transfer mechanism and cleaned by water in one of the water cleaning chambers 603, 604. The cleaned semiconductor substrate W is transferred to the chemical mechanical polishing unit 605 by the substrate transfer mechanism. The chemical mechanical polishing unit 605 removes the unwanted plated copper film from the surface of the semiconductor substrate W, leaving a portion of the plated copper film in the interconnection trench and the interconnection hole. A barrier layer made of TiN or the like is formed on the surface of the semiconductor substrate W, including the inner surfaces of the interconnection trench and the interconnection hole, before the plated copper film is deposited.

Then, the semiconductor substrate W with the remaining plated copper film is transferred to one of the water cleaning chambers 606, 607 by the substrate transfer mechanism and cleaned by water in one of the water cleaning chambers 606, 607. The cleaned semiconductor substrate W is then dried in the drying chamber 608, after which the dried semiconductor substrate W with the remaining plated copper film serving as an interconnection film is placed into a substrate cassette 609-1 in the unloading unit 609.

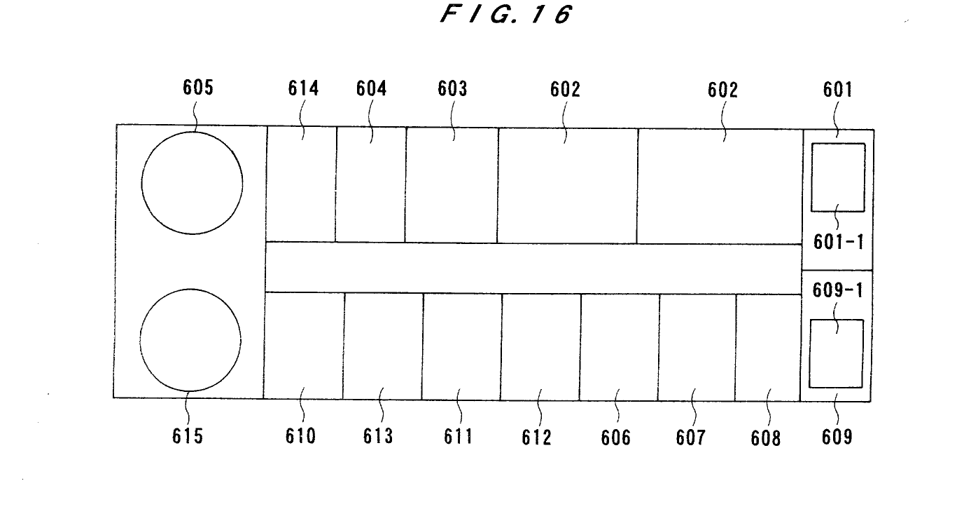

FIG. 16 shows a plan view of still another example of a substrate plating apparatus. The substrate plating apparatus shown in FIG. 16 differs from the substrate plating apparatus shown in FIG. 15 in that it additionally includes a copper plating chamber 602, a water cleaning chamber 610, a pretreatment chamber 611, a protective layer plating chamber 612 for forming a protective plated layer on a plated copper film on a semiconductor substrate, water cleaning chamber 613, 614, and a chemical mechanical polishing unit 615. The loading unit 601, the chambers 602, 602, 603, 604, 614, the chemical mechanical polishing unit 605, 615, the chambers 606, 607, 608, 610, 611, 612, 613, and the unloading unit 609 are combined into a single unitary arrangement as an apparatus.

The substrate plating apparatus shown in FIG. 16 operates as follows: A semiconductor substrate W is supplied from the substrate cassette 601-1 placed in the loading unit 601 successively to one of the copper plating chambers 602, 602. In one of the copper plating chamber 602, 602, a plated copper film is formed on a surface of a semiconductor substrate W having an interconnection region composed of an interconnection trench and an interconnection hole (contact hole). The two copper plating chambers 602, 602 are employed to allow the semiconductor substrate W to be plated with a copper film for a long period of time. Specifically, the semiconductor substrate W may be plated with a primary copper film according to electroless plating in one of the copper plating chamber 602, and then plated with a secondary copper film according to electroplating in the other copper plating chamber 602. The substrate plating apparatus may have more than two copper plating chambers.

The semiconductor substrate W with the plated copper film formed thereon is cleaned by water in one of the water cleaning chambers 603, 604. Then, the chemical mechanical polishing unit 605 removes the unwanted portion of the plated copper film from the surface of the semiconductor substrate W, leaving a portion of the plated copper film in the interconnection trench and the interconnection hole.

Thereafter, the semiconductor substrate W with the remaining plated copper film is transferred to the water cleaning chamber 610, in which the semiconductor substrate W is cleaned with water. Then, the semiconductor substrate W is transferred to the pretreatment chamber 611, and pretreated therein for the deposition of a protective plated layer. The pretreated semiconductor substrate W is transferred to the protective layer-plating chamber 612. In the protective layer plating chamber 612, a protective plated layer is formed on the plated copper film in the interconnection region on the semiconductor substrate W. For example, the protective plated layer is formed with an alloy of nickel (Ni) and boron (B) by electroless plating.

After semiconductor substrate is cleaned in one of the water cleaning chamber 613, 614, an upper portion of the protective plated layer deposited on the plated copper film is polished off to planarize the protective plated layer, in the chemical mechanical polishing unit 615,

After the protective plated layer is polished, the semiconductor substrate W is cleaned by water in one of the water cleaning chambers 606, 607, dried in the drying chamber 608, and then transferred to the substrate cassette 609-1 in the unloading unit 609.

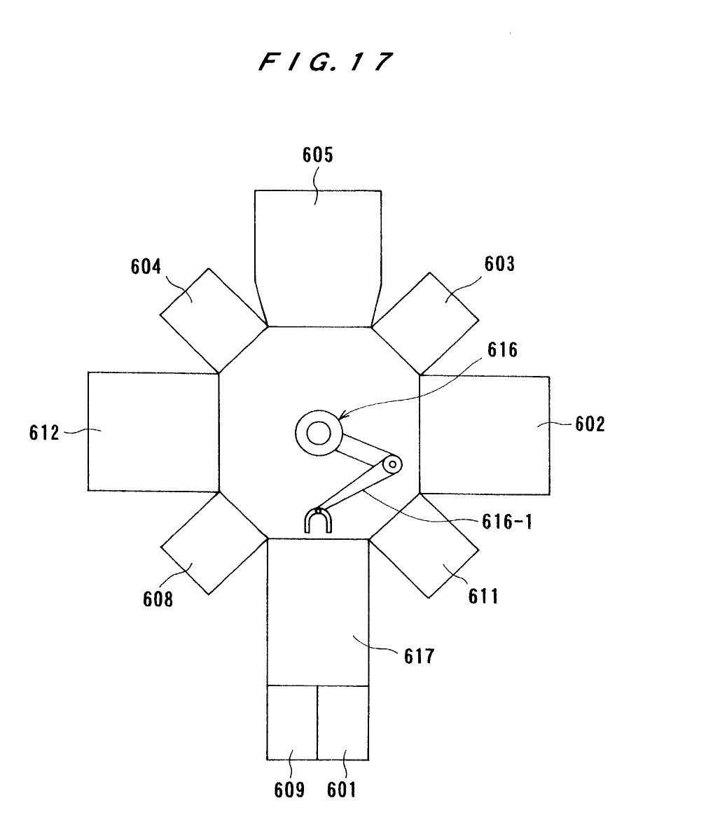

FIG. 17 is a plan view of still another example of a substrate plating apparatus. As shown in FIG. 17, the substrate plating apparatus includes a robot 616 at its center which has a robot arm 616-1, and also has a copper plating chamber 602, a pair of water cleaning chambers 603, 604, a chemical mechanical polishing unit 605, a pretreatment chamber 611, a protective layer plating chamber 612, a drying chamber 608, and a loading/unloading station 617 which are disposed around the robot 616 and positioned within the reach of the robot arm 616-1. A loading unit 601 for loading semiconductor substrates and an unloading unit 609 for unloading semiconductor substrates is disposed adjacent to the loading/unloading station 617. The robot 616, the chambers 602, 603, 604, the chemical mechanical polishing unit 605, the chambers 608, 611, 612, the loading/unloading station 617, the loading unit 601, and the unloading unit 609 are combined into a single unitary arrangement as an apparatus.

The substrate plating apparatus shown in FIG. 17 operates as follows:

A semiconductor substrate to be plated is transferred from the loading unit 601 to the loading/unloading station 617, from which the semiconductor substrate is received by the robot arm 616-1 and transferred thereby to the copper plating chamber 602. In the copper plating chamber 602, a plated copper film is formed on a surface of the semiconductor substrate which has an interconnection region composed of an interconnection trench and an interconnection hole. The semiconductor substrate with the plated copper film formed thereon is transferred by the robot arm 616-1 to the chemical mechanical polishing unit 605. In the chemical mechanical polishing unit 605, the plated copper film is removed from the surface of the semiconductor substrate W, leaving a portion of the plated copper film in the interconnection trench and the interconnection hole.

The semiconductor substrate is then transferred by the robot arm 616-1 to the water-cleaning chamber 604, in which the semiconductor substrate is cleaned by water. Thereafter, the semiconductor substrate is transferred by the robot arm 616-1 to the pretreatment chamber 611, in which the semiconductor substrate is pretreated therein for the deposition of a protective plated layer. The pretreated semiconductor substrate is transferred by the robot arm 616-1 to the protective layer plating chamber 612. In the protective layer plating chamber 612, a protective plated layer is formed on the plated copper film in the interconnection region on the semiconductor substrate W. The semiconductor substrate with the protective plated layer formed thereon is transferred by the robot arm 616-1 to the water cleaning chamber 604, in which the semiconductor substrate is cleaned by water. The cleaned semiconductor substrate is transferred by the robot arm 616-1 to the drying chamber 608, in which the semiconductor substrate is dried. The dried semiconductor substrate is transferred by the robot arm 616-1 to the loading/unloading station 617, from which the plated semiconductor substrate is transferred to the unloading unit 609.

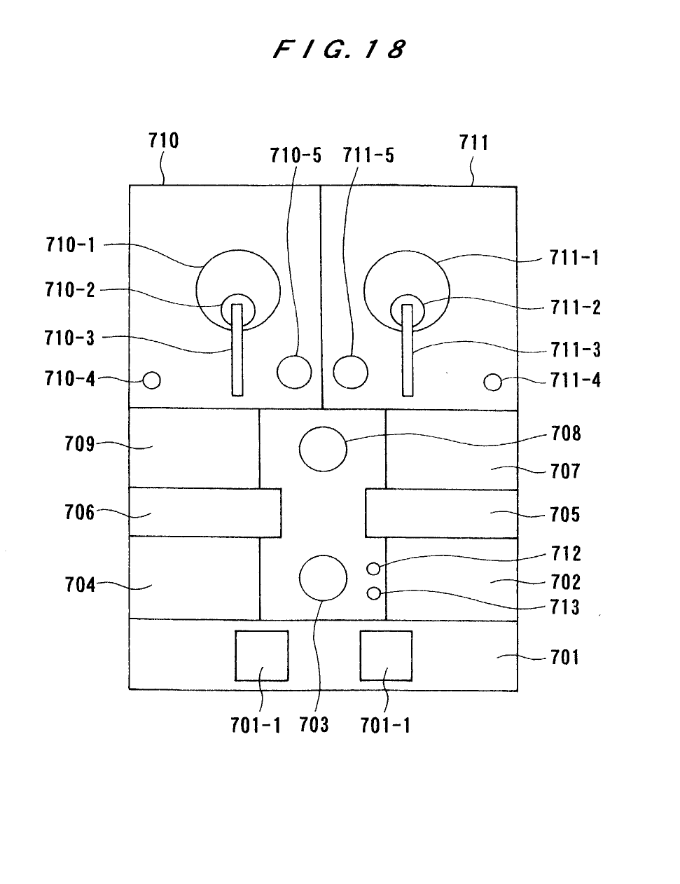

FIG. 18 is a view showing the plan constitution of another example of a semiconductor substrate processing apparatus. The semiconductor substrate processing apparatus is of a constitution in which there are provided a loading/unloading section 701, a plated Cu film forming unit 702, a first robot 703, a third cleaning machine 704, a reversing machine 705, a reversing machine 706, a second cleaning machine 707, a second robot 708, a first cleaning machine 709, a first polishing apparatus 710, and a second polishing apparatus 711. A before-plating and after-plating film thickness measuring instrument 712 for measuring the film thicknesses before and after plating, and a dry state film thickness measuring instrument 713 for measuring the film thickness of a semiconductor substrate W in a dry state after polishing are placed near the first robot 703.

The first polishing apparatus (polishing unit) 710 has a polishing table 710-1, a top ring 710-2, a top ring head 710-3, a film thickness measuring instrument 710-4, and a pusher 710-5. The second polishing apparatus (polishing unit) 711 has a polishing table 711-1, a top ring 711-2, a top ring head 711-3, a film thickness measuring instrument 711-4, and a pusher 711-5.

A cassette 701-1 accommodating the semiconductor substrates W, in which a via hole and a trench for interconnect are formed, and a seed layer is formed thereon is placed on a loading port of the loading/unloading section 701. The first robot 703 takes out the semiconductor substrate W from the cassette 701-1, and carries the semiconductor substrate W into the plated Cu film forming unit 702 where a plated Cu film is formed. At this time, the film thickness of the seed layer is measured with the before-plating and after-plating film thickness measuring instrument 712. The plated Cu film is formed by carrying out hydrophilic treatment of the face of the semiconductor substrate W, and then Cu plating. After formation of the plated Cu film, rinsing or cleaning of the semiconductor substrate W is carried out in the plated Cu film forming unit 702.

When the semiconductor substrate W is taken out from the plated Cu film forming unit 702 by the first robot 703, the film thickness of the plated Cu film is measured with the before-plating and after-plating film thickness measuring instrument 712. The results of its measurement are recorded into a recording device (not shown) as record data on the semiconductor substrate, and are used for judgment of an abnormality of the plated Cu film forming unit 702. After measurement of the film thickness, the first robot 703 transfers the semiconductor substrate W to the reversing machine 705, and the reversing machine 705 reverses the semiconductor substrate W (the surface on which the plated Cu film has been formed faces downward). The first polishing apparatus 710 and the second polishing apparatus 711 perform polishing in a serial mode and a parallel mode. Next, polishing in the serial mode will be described.

In the serial mode polishing, a primary polishing is performed by the polishing apparatus 710, and a secondary polishing is performed by the polishing apparatus 711. The second robot 708 picks up the semiconductor substrate W on the reversing machine 705, and places the semiconductor substrate W on the pusher 710-5 of the polishing apparatus 710. The top ring 710-2 attracts the semiconductor substrate Won the pusher 710-5 by suction, and brings the surface of the plated Cu film of the semiconductor substrate W into contact with a polishing surface of the polishing table 710-1 under pressure to perform a primary polishing. With the primary polishing, the plated Cu film is basically polished. The polishing surface of the polishing table 710-1 is composed of foamed polyurethane such as IC1000, or a material having abrasive grains fixed thereto or impregnated therein. Upon relative movements of the polishing surface and the semiconductor substrate W, the plated Cu film is polished.

After completion of polishing of the plated Cu film, the semiconductor substrate W is returned onto the pusher 710-5 by the top ring 710-2. The second robot 708 picks up the semiconductor substrate W, and introduces it into the first cleaning machine 709. At this time, a chemical liquid may be ejected toward the face and backside of the semiconductor substrate W on the pusher 710-5 to remove particles therefrom or cause particles to be difficult to adhere thereto.

After completion of cleaning in the first cleaning machine 709, the second robot 708 picks up the semiconductor substrate W, and places the semiconductor substrate W on the pusher 711-5 of the second polishing apparatus 711. The top ring 711-2 attracts the semiconductor substrate W on the pusher 711-5 by suction, and brings the surface of the semiconductor substrate W, which has the barrier layer formed thereon, into contact with a polishing surface of the polishing table 711-1 under pressure to perform the secondary polishing. The constitution of the polishing table is the same as the top ring 711-2. With this secondary polishing, the barrier layer is polished. However, there may be a case in which a Cu film and an oxide film left after the primary polishing are also polished.

A polishing surface of the polishing table 711-1 is composed of foamed polyurethane such as IC1000, or a material having abrasive grains fixed thereto or impregnated therein. Upon relative movements of the polishing surface and the semiconductor substrate W, polishing is carried out. At this time, silica, alumina, ceria, or the like is used as abrasive grains or slurry. A chemical liquid is adjusted depending on the type of the film to be polished.

Detection of an end point of the secondary polishing is performed by measuring the film thickness of the barrier layer mainly with the use of the optical film thickness measuring instrument, and detecting the film thickness which has become zero, or the surface of an insulating film comprising SiO₂ shows up. Furthermore, a film thickness measuring instrument with an image processing function is used as the film thickness measuring instrument 711-4 provided near the polishing table 711-1. By use of this measuring instrument, measurement of the oxide film is made, the results are stored as processing records of the semiconductor substrate W, and used for judging whether the semiconductor substrate W in which secondary polishing has been finished can be transferred to a subsequent step or not. If the end point of the secondary polishing is not reached, re-polishing is performed. If over-polishing has been performed beyond a prescribed value due to any abnormality, then the semiconductor substrate processing apparatus is stopped to avoid next polishing so that defective products will not increase.

After completion of the secondary polishing, the semiconductor substrate W is moved to the pusher 711-5 by the top ring 711-2. The second robot 708 picks up the semiconductor substrate W on the pusher 711-5. At this time, a chemical liquid may be ejected toward the face and backside of the semiconductor substrate W on the pusher 711-5 to remove particles therefrom or cause particles to be difficult to adhere thereto.

The second robot 708 carries the semiconductor substrate W into the second cleaning machine 707 where cleaning of the semiconductor substrate W is performed. The constitution of the second cleaning machine 707 is also the same as the constitution of the first cleaning machine 709. The face of the semiconductor substrate W is scrubbed with the PVA sponge rolls using a cleaning liquid comprising pure water to which a surface active agent, a chelating agent, or a pH regulating agent is added. A strong chemical liquid such as DHF is ejected from a nozzle toward the backside of the semiconductor substrate W to perform etching of the diffused Cu thereon. If there is no problem of diffusion, scrubbing cleaning is performed with the PVA sponge rolls using the same chemical liquid as that used for the face.

After completion of the above cleaning, the second robot 708 picks up the semiconductor substrate W and transfers it to the reversing machine 706, and the reversing machine 706 reverses the semiconductor substrate W. The semiconductor substrate W which has been reversed is picked up by the first robot 703, and transferred to the third cleaning machine 704. In the third cleaning machine 704, megasonic water excited by ultrasonic vibrations is ejected toward the face of the semiconductor substrate W to clean the semiconductor substrate W. At this time, the face of the semiconductor substrate W may be cleaned with a known pencil type sponge using a cleaning liquid comprising pure water to which a surface active agent, a chelating agent, or a pH regulating agent is added. Thereafter, the semiconductor substrate W is dried by spin-drying.

As described above, if the film thickness has been measured with the film thickness measuring instrument 711-4 provided near the polishing table 711-1, then the semiconductor substrate W is not subjected to further process and is accommodated into the cassette placed on the unloading port of the loading/unloading section 701.

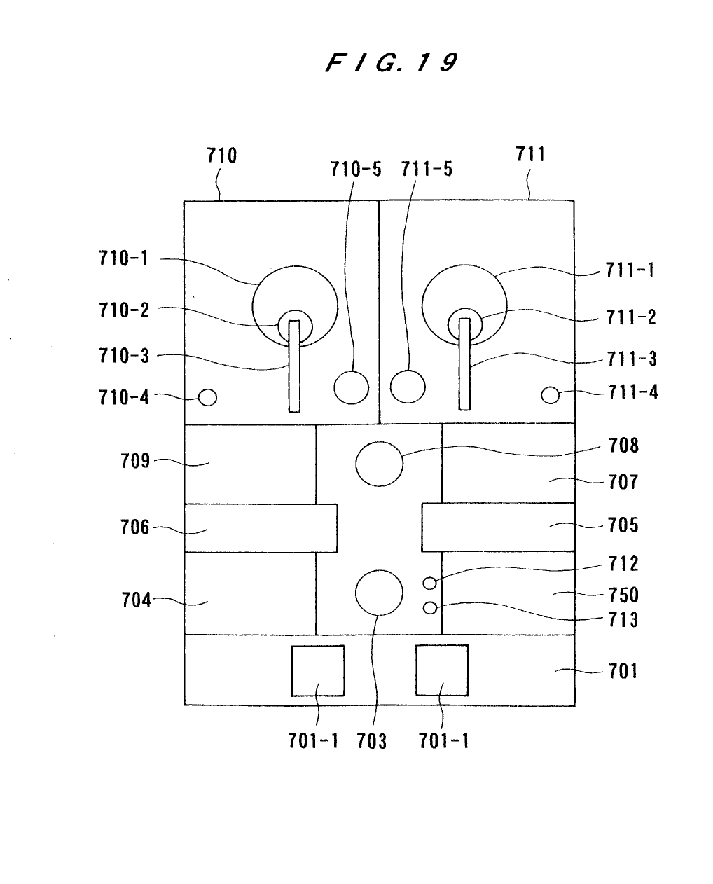

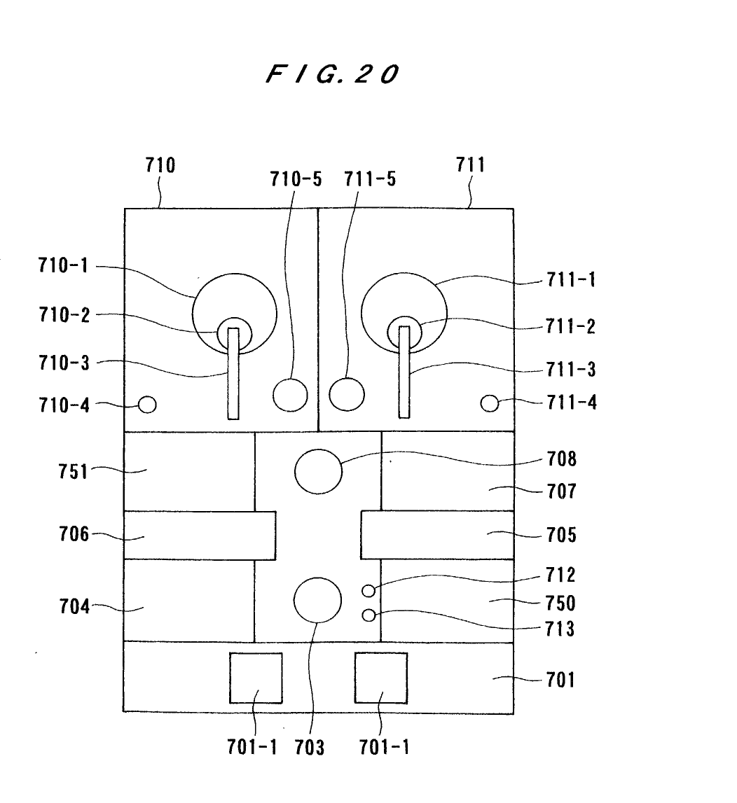

FIG. 19 is a view showing the plan constitution of another example of a semiconductor substrate processing apparatus. The substrate processing apparatus differs from the substrate processing apparatus shown in FIG. 18 in that a cap plating unit 750 is provided instead of the plated Cu film forming unit 702 in FIG. 18.

A cassette 701-1 accommodating the semiconductor substrates W formed plated Cu film is placed on a load port of a loading/unloading section 701. The semiconductor substrate W taken out from the cassette 701-1 is transferred to the first polishing apparatus 710 or second polishing apparatus 711 in which the surface of the plated Cu film is polished. After completion of polishing of the plated Cu film, the semiconductor substrate W is cleaned in the first cleaning machine 709.

After completion of cleaning in the first cleaning machine 709, the semiconductor substrate W is transferred to the cap plating unit 750 where cap plating is applied onto the surface of the plated Cu film with the aim of preventing oxidation of plated Cu film due to the atmosphere. The semiconductor substrate to which cap plating has been applied is carried by the second robot 708 from the cap plating unit 750 to the second cleaning machine 707 where it is cleaned with pure water or deionized water. The semiconductor substrate after completion of cleaning is returned into the cassette 701-1 placed on the loading/unloading section 701.

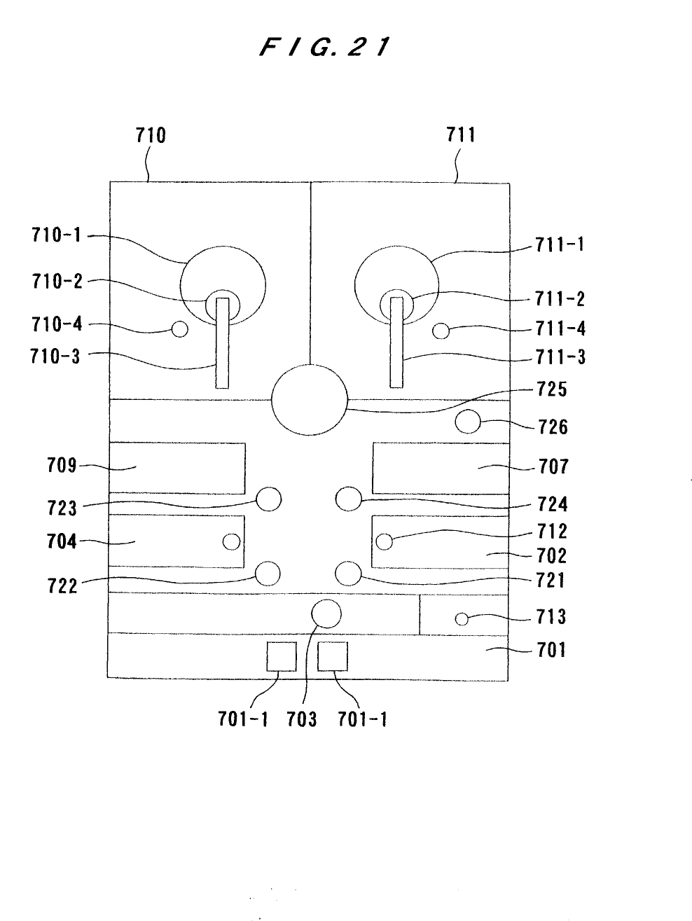

FIG. 20 is a view showing the plan constitution of still another example of a semiconductor substrate processing apparatus. The substrate processing apparatus differs from the substrate processing apparatus shown in FIG. 19 in that an annealing unit 751 is provided instead of the first cleaning machine 709 in FIG. 19.

The semiconductor substrate W, which is polished in the polishing unit 710 or 711, and cleaned in the second cleaning machine 707 described above, is transferred to the cap plating unit 750 where cap plating is applied onto the surface of the plated Cu film. The semiconductor substrate to which cap plating has been applied is carried by the second robot 708 from the cap plating unit 750 to the second cleaning machine 707 where it is cleaned.

After completion of cleaning in the second cleaning machine 707, the semiconductor substrate W is transferred to the annealing unit 751 in which the substrate is annealed, whereby the plated Cu film is alloyed so as to increase the electromigration resistance of the plated Cu film. The semiconductor substrate W to which annealing treatment has been applied is carried from the annealing unit 751 to the second cleaning machine 707 where it is cleaned with pure water or deionized water. The semiconductor substrate W after completion of cleaning is returned into the cassette 701-1 placed on the loading/unloading section 701.

FIG. 21 is a view showing a plan layout constitution of another example of the substrate processing apparatus. In FIG. 21, portions denoted by the same reference numerals as those in FIG. 18 show the same or corresponding portions. In the substrate processing apparatus, a pusher indexer 725 is disposed close to a first polishing apparatus 710 and a second polishing apparatus 711. Substrate placing tables 721, 722 are disposed close to a third cleaning machine 704 and a plated Cu film forming unit 702, respectively. A robot 723 is disposed close to a first cleaning machine 709 and the third cleaning machine 704. Further, a robot 724 is disposed close to a second cleaning machine 707 and the plated Cu film forming unit 702, and a dry state film thickness measuring instrument 713 is disposed close to a loading/unloading section 701 and a first robot 703.

In the substrate processing apparatus of the above constitution, the first robot 703 takes out a semiconductor substrate W from a cassette 701-1, placed on the load port of the loading/unloading section 701. After the film thicknesses of a barrier layer and a seed layer are measured with the dry state film thickness measuring instrument 713, the first robot 703 places the semiconductor substrate W on the substrate placing table 721. In the case where the dry state film thickness measuring instrument 713 is provided on the hand of the first robot 703, the film thicknesses are measured thereon, and the substrate is placed on the substrate placing table 721. The second robot 723 transfers the semiconductor substrate W on the substrate placing table 721 to the plated Cu film forming unit 702 in which a plated Cu film is formed. After formation of the plated Cu film, the film thickness of the plated Cu film is measured with a before-plating and after-plating film thickness measuring instrument 712. Then, the second robot 723 transfers the semiconductor substrate W to the pusher indexer 725 and loads it thereon.

[Serial Mode]

In the serial mode, a top ring 710-2 holds the semiconductor substrate W on the pusher indexer 725 by suction, transfers it to a polishing table 710-1, and presses the semiconductor substrate W against a polishing surface on the polishing table 710-1 to perform polishing. Detection of the end point of polishing is performed by the same method as described above. The semiconductor substrate W after completion of polishing is transferred to the pusher indexer 725 by the top ring 710-2, and loaded thereon. The second robot 723 takes out the semiconductor substrate W, and carries it into the first cleaning machine 709 for cleaning. Then, the semiconductor substrate W is transferred to the pusher indexer 725, and loaded thereon.

A top ring 711-2 holds the semiconductor substrate W on the pusher indexer 725 by suction, transfers it to a polishing table 711-1, and presses the semiconductor substrate W against a polishing surface on the polishing table 711-1 to perform polishing. Detection of the end point of polishing is performed by the same method as described above. The semiconductor substrate W after completion of polishing is transferred to the pusher indexer 725 by the top ring 711-2, and loaded thereon. The third robot 724 picks up the semiconductor substrate W, and its film thickness is measured with a film thickness measuring instrument 726. Then, the semiconductor substrate W is carried into the second cleaning machine 707 for cleaning. Thereafter,the semiconductor substrate W is carried into the third cleaning machine 704, where it is cleaned and then dried by spin-drying. Then, the semiconductor substrate W is picked up by the third robot 724, and placed on the substrate placing table 722.

[Parallel Mode]

In the parallel mode, the top ring 710-2 or 711-2 holds the semiconductor substrate W on the pusher indexer 725 by suction, transfers it to the polishing table 710-1 or 711-1, and presses the semiconductor substrate W against the polishing surface on the polishing table 710-1 or 711-1 to perform polishing. After measurement of the film thickness, the third robot 724 picks up the semiconductor substrate W, and places it on the substrate placing table 722.

The first robot 703 transfers the semiconductor substrate W on the substrate placing table 722 to the dry state film thickness measuring instrument 713. After the film thickness is measured, the semiconductor substrate W is returned to the cassette 701-1 of the loading/unloading section 701.

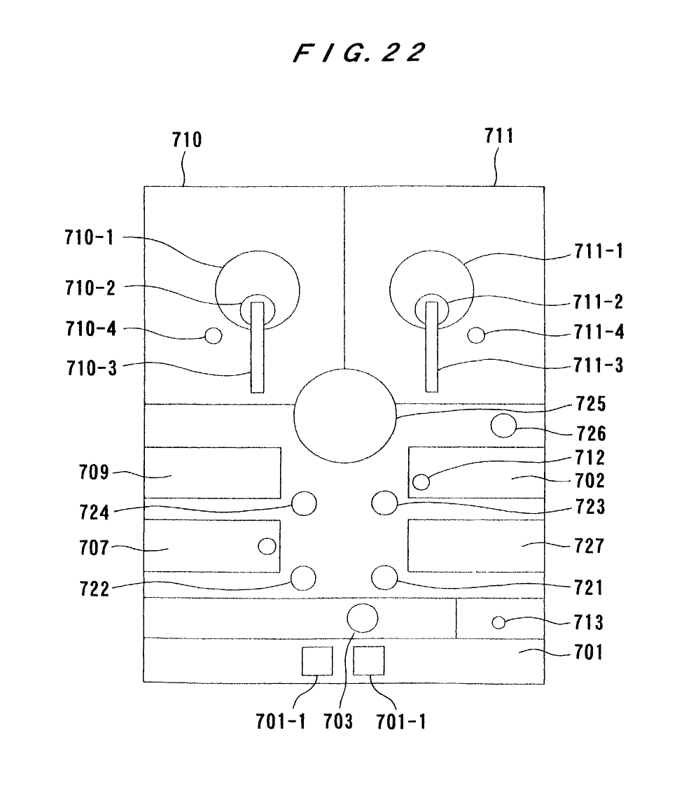

FIG. 22 is a view showing another plan layout constitution of the substrate processing apparatus. The substrate processing apparatus is such a substrate processing apparatus which forms a seed layer and a plated Cu film on a semiconductor substrate W having no seed layer formed thereon, and polishes these films to form interconnects.

In the substrate polishing apparatus, a pusher indexer 725 is disposed close to a first polishing apparatus 710 and a second polishing apparatus 711, substrate placing tables 721, 722 are disposed close to a second cleaning machine 707 and a seed layer forming unit 727, respectively, and a robot 723 is disposed close to the seed layer forming unit 727 and a plated Cu film forming unit 702. Further, a robot 724 is disposed close to a first cleaning machine 709 and the second cleaning machine 707, and a dry state film thickness measuring instrument 713 is disposed close to a loading/unloading section 701 and a first robot 703.

The first robot 703 takes out a semiconductor substrate W having a barrier layer thereon from a cassette 701-1 placed on the load port of the loading/unloading section 701, and places it on the substrate placing table 721. Then, the second robot 723 transfers the semiconductor substrate W to the seed layer forming unit 727 where a seed layer is formed. The seed layer is formed by electroless plating. The second robot 723 enables the semiconductor substrate having the seed layer formed thereon to be measured in thickness of the seed layer by the before-plating and after-plating film thickness measuring instrument 712. After measurement of the film thickness, the semiconductor substrate is carried into the plated Cu film forming unit 702 where a plated Cu film is formed.

After formation of the plated Cu film, its film thickness is measured, and the semiconductor substrate is transferred to a pusher indexer 725. A top ring 710-2 or 711-2 holds the semiconductor substrate W on the pusher indexer 725 by suction, and transfers it to a polishing table 710-1 or 711-1 to perform polishing. After polishing, the top ring 710-2 or 711-2 transfers the semiconductor substrate W to a film thickness measuring instrument 710-4 or 711-4 to measure the film thickness. Then, the top ring 710-2 or 711-2 transfers the semiconductor substrate W to the pusher indexer 725, and places it thereon.

Then, the third robot 724 picks up the semiconductor substrate W from the pusher indexer 725, and carries it into the first cleaning machine 709. The third robot 724 picks up the cleaned semiconductor substrate W from the first cleaning machine 709, carries it into the second cleaning machine 707, and places the cleaned and dried semiconductor substrate on the substrate placing table 722. Then, the first robot 703 picks up the semiconductor substrate W, and transfers it to the dry state film thickness measuring instrument 713 in which the film thickness is measured, and the first robot 703 carries it into the cassette 701-1 placed on the unload port of the loading/unloading section 701.

In the substrate processing apparatus shown in FIG. 22, interconnects are formed by forming a barrier layer, a seed layer and a plated Cu film on a semiconductor substrate W having a via hole or a trench of a circuit pattern formed therein, and polishing them.

The cassette 701-1 accommodating the semiconductor substrates W before formation of the barrier layer is placed on the load port of the loading/unloading section 701. The first robot 703 takes out the semiconductor substrate W from the cassette 701-1 placed on the load port of the loading/unloading section 701, and places it on the substrate placing table 721. Then, the second robot 723 transfers the semiconductor substrate W to the seed layer forming unit 727 where a barrier layer and a seed layer are formed. The barrier layer and the seed layer are formed by electroless plating. The second robot 723 brings the semiconductor substrate W having the barrier layer and the seed layer formed thereon to the before-plating and after-plating film thickness measuring instrument 712 which measures the film thicknesses of the barrier layer and the seed layer. After measurement of the film thicknesses, the semiconductor substrate W is carried into the plated Cu film forming unit 702 where a plated Cu film is formed.

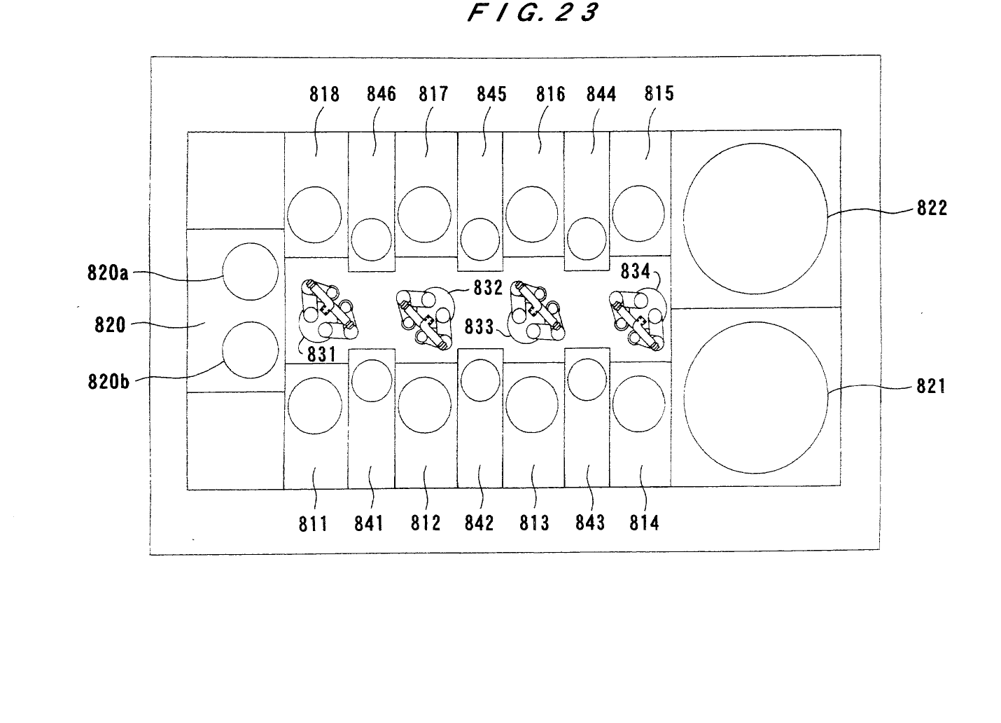

FIG. 23 is a view showing plan layout constitution of another example of the substrate processing apparatus. In the substrate processing apparatus, there are provided a barrier layer forming unit 811, a seed layer forming unit 812, a plated film forming unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading section 820, a first polishing apparatus 821, a second polishing apparatus 822, a first robot 831, a second robot 832, a third robot 833, and a fourth robot 834. The film thickness measuring instruments 841, 842 and 846 are units, have the same size as the frontage dimension of other units (plating, cleaning, annealing units, and the like), and are thus interchangeable.

In this example, an electroless Ru plating apparatus can be used as the barrier layer forming unit 811, an electroless Cu plating apparatus as the seed layer forming unit 812, and an electroplating apparatus as the plated film forming unit 813.

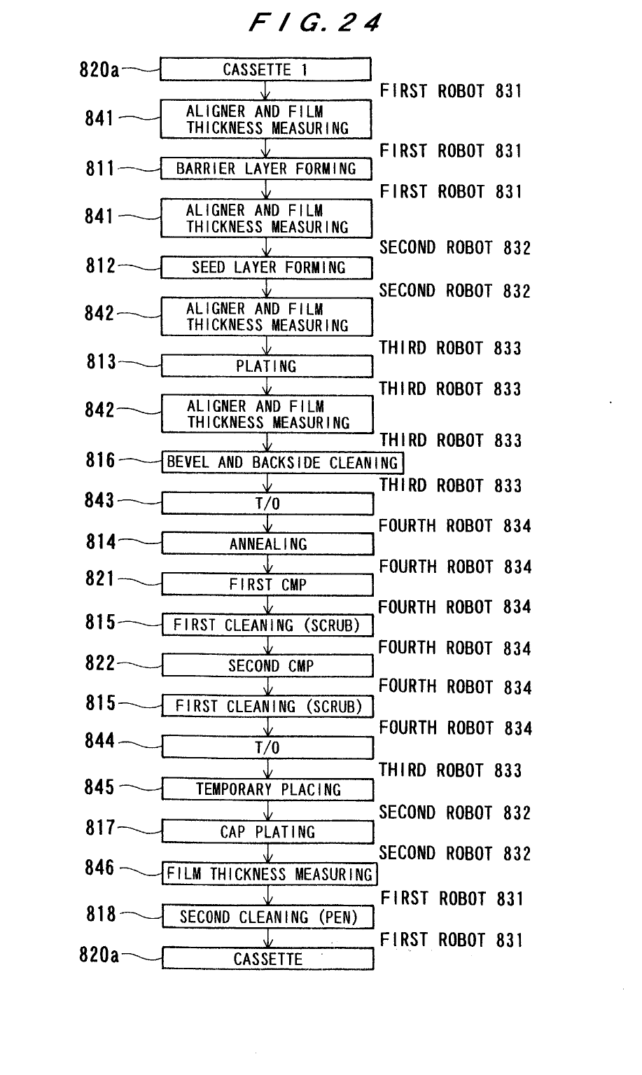

FIG. 24 is a flow chart showing the flow of the respective steps in the present substrate processing apparatus. The respective steps in the apparatus will be described according to this flow chart. First, a semiconductor substrate taken out by the first robot 831 from a cassette 820a placed on the load and unload section 820 is placed in the first aligner and film thickness measuring instrument 841, in such a state that its surface, to be plated, faces upward. In order to set a reference point for a position at which film thickness measurement is made, notch alignment for film thickness measurement is performed, and then film thickness data on the semiconductor substrate before formation of a Cu film are obtained.

Then, the semiconductor substrate is transferred to the barrier layer forming unit 811 by the first robot 831. The barrier layer forming unit 811 is such an apparatus for forming a barrier layer on the semiconductor substrate by electroless Ru plating, and the barrier layer forming unit 811 forms an Ru film as a film for preventing Cu from diffusing into an interlayer insulator film (e.g. SiO₂) of a semiconductor device. The semiconductor substrate discharged after cleaning and drying steps is transferred by the first robot 831 to the first aligner and film thickness measuring instrument 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless Cu plating. The semiconductor substrate discharged after cleaning and drying steps is transferred by the second robot 832 to the second aligner and film thickness measuring instrument 842 for determination of a notch position, before the semiconductor substrate is transferred to the plated film forming unit 813, which is an impregnation plating unit, and then notch alignment for Cu plating is performed by the film thickness measuring instrument 842. If necessary, the film thickness of the semiconductor substrate before formation of a Cu film may be measured again in the film thickness measuring instrument 842.

The semiconductor substrate which has completed notch alignment is transferred by the third robot 833 to the plated film forming unit 813 where Cu plating is applied to the semiconductor substrate. The semiconductor substrate discharged after cleaning and drying steps is transferred by the third robot 833 to the bevel and backside cleaning unit 816 where an unnecessary Cu film (seed layer) at a peripheral portion of the semiconductor substrate is removed. In the bevel and backside cleaning unit 816, the bevel is etched in a preset time, and Cu adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the Cu film formed by plating, and based on the obtained results, the bevel etching time may be changed arbitrarily to carry out etching. The region etched by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing a interconnection portion. Before and/or after annealing treatment, the semiconductor substrate is carried into the second aligner and film thickness measuring instrument 842 where the film thickness of a copper film formed on the semiconductor substrate is measured. Then, the semiconductor substrate is carried by the fourth robot 834 into the first polishing apparatus 821 in which the Cu film and the seed layer of the semiconductor substrate are polished.

At this time, desired abrasive grains or the like are used, but fixed abrasive may be used in order to prevent dishing and enhance flatness of the face. After completion of primary polishing, the semiconductor substrate is transferred by the fourth robot 834 to the first cleaning unit 815 where it is cleaned. This cleaning is scrub-cleaning in which rolls having substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the face. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot.

The semiconductor substrate is transferred by the second robot 832 from the substrate temporary placing table 845 to the cap plating unit 817 where cap plating is applied onto the Cu surface with the aim of preventing oxidation of Cu due to the atmosphere. The semiconductor substrate to which cap plating has been applied is carried by the second robot 832 from the cap plating unit 817 to the third film thickness measuring instrument 846 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading section 820.

The aligner and film thickness measuring instrument 841 and the aligner and film thickness measuring instrument 842 perform positioning of the notch portion of the substrate and measurement of the film thickness.

The seed layer forming unit 812 may be omitted. In this case, a plated film may be formed on a barrier layer directly in a plated film forming unit 813.

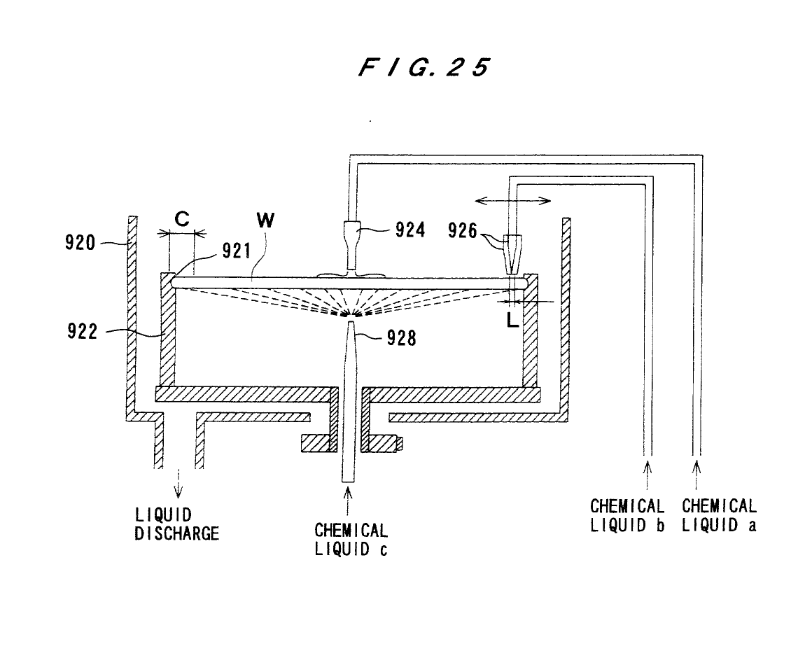

The bevel and backside cleaning unit 816 can perform an edge (bevel) Cu etching and a backside cleaning at the same time, and can suppress growth of a natural oxide film of copper at the circuit formation portion on the surface of the substrate. FIG. 25 shows a schematic view of the bevel and backside cleaning unit 816. As shown in FIG. 25, the bevel and backside cleaning unit 816 has a substrate holding portion 922 positioned inside a bottomed cylindrical waterproof cover 920 and adapted to rotate a substrate W at a high speed, in such a state that the face of the substrate W faces upwardly, while holding the substrate W horizontally by spin chucks 921 at a plurality of locations along a circumferential direction of a peripheral edge portion of the substrate, a center nozzle 924 placed above a nearly central portion of the face of the substrate W held by the substrate holding portion 922, and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this cleaning apparatus will be described. First, the semiconductor substrate W is horizontally rotated integrally with the substrate holding portion 922, with the substrate being held horizontally by the spin chucks 921 of the substrate holding portion 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the peripheral edge portion C of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition which will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the presence of annealing, thin interconnection showed no voids. Thus, the degree of grain growth is presumed to be involved in these phenomena. That is, the following mechanism can be speculated: Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit 814 are such that hydrogen (2% or less) is added in a gas atmosphere, the temperature is in the range of 300° C. to 400° C., and the time is in the range of 1 to 5 minutes. Under these conditions, the above effects were obtained.

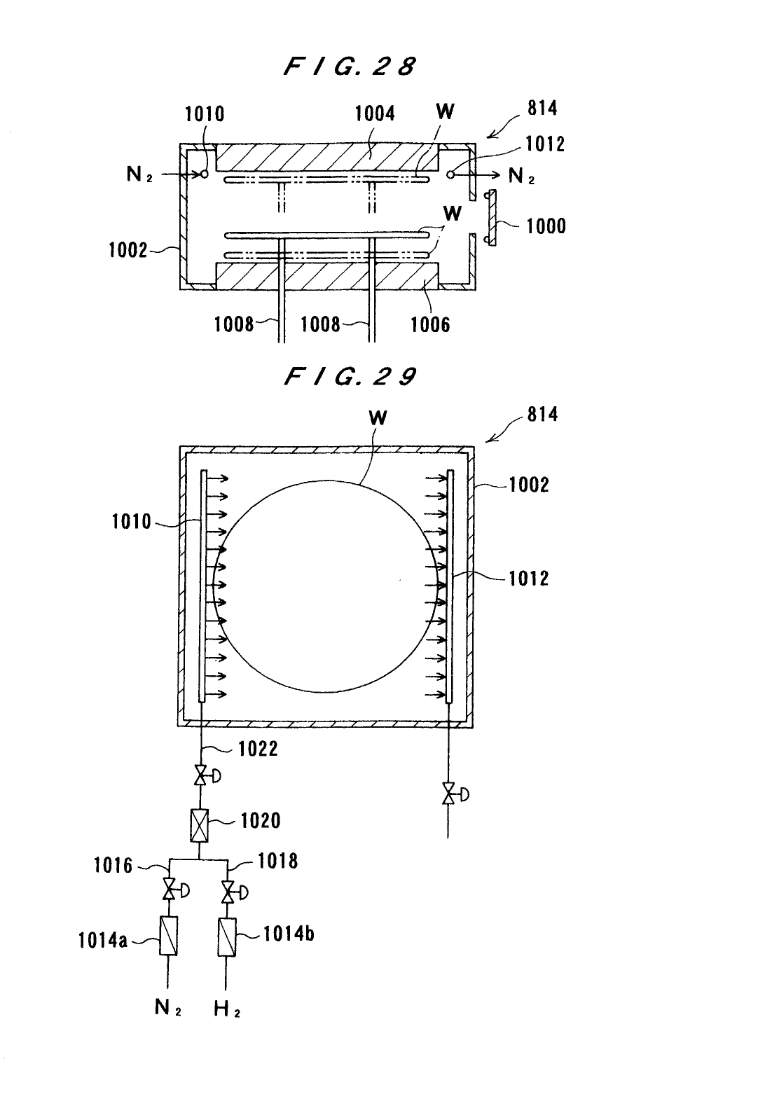

FIGS. 28 and 29 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing a cooling water inside the plate. The annealing unit 814 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After the completion of the annealing, the elevating pins 1008 are lowered down to a position at which the distance between the semiconductor substrate W held on the elevating pins 1008 and the cool plate 1006 becomes e.g. 0-0.5 mm. In this state, by introducing a cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several % of H₂ gas is used as the above antioxidant gas. However, N₂ gas may be used singly.

The annealing unit may be placed in the electroplating apparatus.

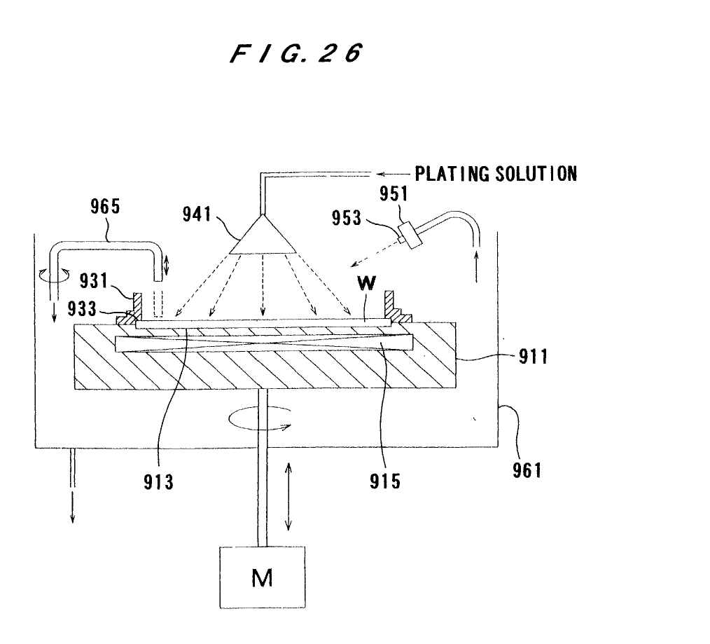

FIG. 26 is a schematic constitution drawing of the electroless plating apparatus. As shown in FIG. 26, this electroless plating apparatus comprises holding means 911 for holding a semiconductor substrate W to be plated on its upper surface, a dam member 931 for contacting a peripheral edge portion of a surface to be plated (upper surface) of the semiconductor substrate W held by the holding means 911 to seal the peripheral edge portion, and a shower head 941 for supplying a plating solution to the surface, to be plated, of the semiconductor substrate W having the peripheral edge portion sealed with the dam member 931. The electroless plating apparatus further comprises cleaning liquid supply means 951 disposed near an upper outer periphery of the holding means 911 for supplying a cleaning liquid to the surface, to be plated, of the semiconductor substrate W, a recovery vessel 961 for recovering a cleaning liquid or the like (plating waste liquid) discharged, a plating solution recovery nozzle 965 for sucking in and recovering the plating solution held on the semiconductor substrate W, and a motor M for rotationally driving the holding means 911. The respective members will be described below.

The holding means 911 has a substrate placing portion 913 on its upper surface for placing and holding the semiconductor substrate W. The substrate placing portion 913 is adapted to place and fix the semiconductor substrate W. Specifically, the substrate placing portion 913 has a vacuum attracting mechanism (not shown) for attracting the semiconductor substrate W to a backside thereof by vacuum suction. A backside heater 915, which is planar and heats the surface, to be plated, of the semiconductor substrate W from underside to keep it warm, is installed on the backside of the substrate placing portion 913. The backside heater 915 is composed of, for example, a rubber heater. This holding means 911 is adapted to be rotated by the motor M and is movable vertically by raising and lowering means (not shown).

The dam member 931 is tubular, has a seal portion 933 provided in a lower portion thereof for sealing the outer peripheral edge of the semiconductor substrate W, and is installed so as not to move vertically from the illustrated position.

The shower head 941 is of a structure having many nozzles provided at the front end for scattering the supplied plating solution in a shower form and supplying it substantially uniformly to the surface, to be plated, of the semiconductor substrate W. The cleaning liquid supply means 951 has a structure for ejecting a cleaning liquid from a nozzle 953.

The plating solution recovery nozzle 965 is adapted to be movable upward and downward and swingable, and the front end of the plating solution recovery nozzle 965 is adapted to be lowered inwardly of the dam member 931 located on the upper surface peripheral edge portion of the semiconductor substrate W and to suck in the plating solution on the semiconductor substrate W.

Next, the operation of the electroless plating apparatus will be described. First, the holding means 911 is lowered from the illustrated state to provide a gap of a predetermined dimension between the holding means 911 and the dam member 931, and the semiconductor substrate W is placed on and fixed to the substrate placing portion 913. An 8-inch substrate, for example, is used as the semiconductor substrate W.

Then, the holding means 911 is raised to bring its upper surface into contact with the lower surface of the dam member 931 as illustrated, and the outer periphery of the semiconductor substrate W is sealed with the seal portion 933 of the dam member 931. At this time, the surface of the semiconductor substrate W is in an open state.

Then, the semiconductor substrate W itself is directly heated by the backside heater 915 to render the temperature of the semiconductor substrate W, for example, 70° C. (maintained until termination of plating). Then, the plating solution heated, for example, to 50° C. is ejected from the shower head 941 to pour the plating solution over substantially the entire surface of the semiconductor substrate W. Since the surface of the semiconductor substrate W is surrounded by the dame member 931, the poured plating solution is all held on the surface of the semiconductor substrate W. The amount of the supplied plating solution may be a small amount which will become a 1 mm thickness (about 30 ml) on the surface of the semiconductor substrate W. The depth of the plating solution held on the surface to be plated may be 10 mm or less, and may be even 1 mm as in this embodiment. If a small amount of the supplied plating solution is sufficient, the heating apparatus for heating the plating solution may be of a small size. In this example, the temperature of the semiconductor substrate W is raised to 70° C., and the temperature of the plating solution is raised to 50° C. by heating. Thus, the surface, to be plated, of the semiconductor substrate W becomes, for example, 60° C., and hence a temperature optimal for a plating reaction in this example can be achieved.

The semiconductor substrate W is instantaneously rotated by the motor M to perform uniform liquid wetting of the surface to be plated, and then plating of the surface to be plated is performed in such a state that the semiconductor substrate W is in a stationary state. Specifically, the semiconductor substrate W is rotated at 100 rpm or less for only 1 second to uniformly wet the surface, to be plated, of the semiconductor substrate W with the plating solution. Then, the semiconductor substrate W is kept stationary, and electroless plating is performed for 1 minute. The instantaneous rotating time is 10 seconds or less at the longest.

After completion of the plating treatment, the front end of the plating solution recovery nozzle 965 is lowered to an area near the inside of the dam member 931 on the peripheral edge portion of the semiconductor substrate W to suck in the plating solution. At this time, if the semiconductor substrate W is rotated at a rotational speed of, for example, 100 rpm or less, the plating solution remaining on the semiconductor substrate W can be gathered in the portion of the dam member 931 on the peripheral edge portion of the semiconductor substrate W under centrifugal force, so that recovery of the plating solution can be performed with a good efficiency and a high recovery rate. The holding means 911 is lowered to separate the semiconductor substrate W from the dam member 931. The semiconductor substrate W is started to be rotated, and the cleaning liquid (ultra-pure water) is jetted at the plated surface of the semiconductor substrate W from the nozzle 953 of the cleaning liquid supply means 951 to cool the plated surface, and simultaneously perform dilution and cleaning, thereby stopping the electroless plating reaction. At this time, the cleaning liquid jetted from the nozzle 953 may be supplied to the dam member 931 to perform cleaning of the dam member 931 at the same time. The plating waste liquid at this time is recovered into the recovery vessel 961 and discarded.

Then, the semiconductor substrate W is rotated at a high speed by the motor M for spin-drying, and then the semiconductor substrate W is removed from the holding means 911.

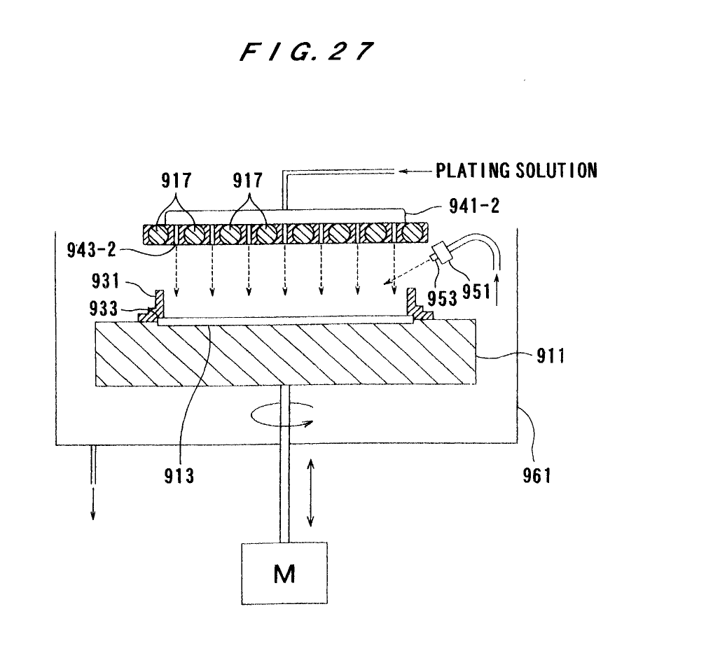

FIG. 27 is a schematic constitution drawing of another electroless plating apparatus. The electroless plating apparatus of FIG. 27 is different from the electroless plating apparatus of FIG. 26 in that instead of providing the backside heater 915 in the holding means 911, lamp heaters 917 are disposed above the holding means 911, and the lamp heaters 917 and a shower head 941-2 are integrated. For example, a plurality of ring-shaped lamp heaters 917 having different radii are provided concentrically, and many nozzles 943-2 of the shower head 941-2 are open in a ring form from the gaps between the lamp heaters 917. The lamp heaters 917 may be composed of a single spiral lamp heater, or may be composed of other lamp heaters of various structures and arrangements.

Even with this constitution, the plating solution can be supplied from each nozzle 943-2 to the surface, to be plated, of the semiconductor substrate W substantially uniformly in a shower form. Further, heating and heat retention of the semiconductor substrate W can be performed by the lamp heaters 917 directly uniformly. The lamp heaters 917 heat not only the semiconductor substrate W and the plating solution, but also ambient air, thus exhibiting a heat retention effect on the semiconductor substrate W.

Direct heating of the semiconductor substrate W by the lamp heaters 917 requires the lamp heaters 917 with a relatively large electric power consumption. In place of such lamp heaters 917, lamp heaters 917 with a relatively small electric power consumption and the backside heater 915 shown in FIG. 25 may be used in combination to heat the semiconductor substrate W mainly with the backside heater 915 and to perform heat retention of the plating solution and ambient air mainly by the lamp heaters 917. In the same manner as in the aforementioned embodiment, means for directly or indirectly cooling the semiconductor substrate W may be provided to perform temperature control.

The cap plating described above is preferably performed by electroless plating process, but may be performed by electroplating process.

Although certain preferred embodiments of the present invention have been shown and described in detail, it should be understood that various changes and modifications may be made therein without departing from the scope of the appended claims.

What is claimed is:

1. An electroplating apparatus for plating a substrate for plating a substrate by filling a plating solution between the substrate and an anode, and by applying a voltage between the substrate and the anode, comprising:
a voltage monitor for monitoring the voltage applied between the substrate and the anode, and detecting the end point of the electroplating.

2. The electroplating apparatus according to claim 1, wherein the monitoring of the voltage applied between the substrate and the anode is carried out while the plating is in progress.

3. An electroplating apparatus for plating a substrate for plating a substrate by filling a plating solution between the substrate and an anode, and by applying a voltage between the substrate and the anode, comprising: a detection circuit which is formed by connecting at least two cathode electrodes that are for use in the plating;
a detection power source for applying a constant voltage to the detection circuit; and
a current monitor for monitoring an electric current that flows through the detection circuit and detecting the end point of the electroplating.

4. The electroplating apparatus according to claim 3, wherein the monitoring of the electric current that flows through the detection circuit is carried out while the plating is interrupted.

5. An electroplating apparatus for plating a substrate for plating a substrate by filling a plating solution between the substrate and an anode, and by applying a voltage between the substrate and the anode, comprising:
a voltage monitor for monitoring the voltage applied between the substrate and the anode, and detecting the end point of the electroplating;
a detection circuit which is formed by connecting at least two cathode electrodes that are for use in the plating;
a detection power source for applying a constant voltage to the detection circuit; and
a current monitor for monitoring an electric current that flows through the detection circuit and detecting the end point of the electroplating.

6. The electroplating apparatus according to claim 5, wherein the monitoring of the voltage applied between the substrate and the anode is carried out while the plating is in progress, whereas the monitoring of the electric current that flows through the detection circuit is carried out while the plating is interrupted.

7. An electroplating method, comprising:
plating a substrate by filling a plating solution between the substrate held by a substrate holding portion and an anode, and by applying a voltage between the substrate and the anode; and
monitoring the voltage applied between the substrate and the anode so as to detect the end point of the electroplating.

8. The electroplating method according to claim 7, wherein the monitoring of the voltage applied between the substrate and the anode is carried out while the plating is in progress.

9. An electroplating method, comprising:
plating a substrate by filling a plating solution between the substrate held by a substrate holding portion and an anode, and by applying a voltage between the substrate and the anode;
forming a detection circuit by connecting at least two cathode electrodes that are for use in the plating; and
applying a constant voltage to the detection circuit and monitoring an electric current that flows through the detection circuit so as to detect the end point of the electroplating.

10. The electroplating method according to claim 9, wherein the monitoring of the electric current that flows through the detection circuit is carried out while the plating is interrupted.
